(19) United States
(12) Patent Application Publication
(10) Pub. No.: US 2026/0121968 A1
(43) Pub. Date: Apr. 30, 2026

(54) Sustainability-Aware Collaboration Session Routing

(71) Applicant: Cisco Technology, Inc., San Jose, CA (US)

(72) Inventors: James Eric Yarbrough, RESEARCH TRIANGLE PARK, NC (US); Jason Kuhne, BOXBOROUGH, MA (US); Steven Michael Holl, TAMPA, FL (US); Gonzalo A. Salgueiro, Raleigh, NC (US); Jason Coleman, Hendersonville, CA (US)

(21) Appl. No.: 18/932,412

(22) Filed: Oct. 30, 2024

(51) Int. Cl. H04L 45/00; H04L 65/1069

(52) U.S. Cl. CPC H04L 45/14; H04L 65/1069

(57) ABSTRACT

Existing session routing strategies tend to primarily focus on performance and cost efficiency, with less emphasis on energy consumption or sustainability. To address this, devices, systems, methods, and processes that facilitate sustainability-aware collaboration session activity routing are described herein. A session control logic receives attributes of a plurality of network devices and determines sustainability scores for the plurality of network devices. The session control logic further selects a target network device from the plurality of network devices based on the sustainability scores, and directs a collaboration session activity to the selected target network device. Thus, the target network device receives the collaboration session activity in response to its sustainability score being optimal in comparison to respective sustainability scores of peer network devices. As a result, the session control logic explicitly considers sustainability impact of a routing decision when determining routes, leading to improved energy efficiency or reduced environmental impact.

The present disclosure relates to collaborative communication sessions. More particularly, the present disclosure relates to sustainability-aware routing of collaboration sessions in communication networks.

### BACKGROUND

Existing session routing technologies, such as circuit-switched networks and packet-switched networks like voice over internet protocol (VOIP), have greatly improved the efficiency and flexibility of telecommunications. Dynamic session routing systems, which make real-time decisions based on network conditions, have optimized session quality, reduced latency, and lowered operational costs. Dynamic session routing systems further utilize collaboration session routing that directs calls, file sharing, video conferences, or other forms of communication through collaboration platforms. Unlike traditional telephony call routing, which typically focuses on voice communication, collaboration session routing integrates various modes of communication (voice, video, messaging, file sharing, virtual meetings, etc.) and involves multiple devices and endpoints, such as computers, mobile phones, and specialized conferencing systems. Modern collaboration session platforms use Selective Forwarding Units (SFUs) to optimize media streams, and cloud infrastructure with load balancing to enhance scalability and fault tolerance. These technologies work together to maintain seamless, secure, and real-time collaboration across varied networks and devices.

Despite these advantages, current collaboration session routing systems tend to primarily focus on performance and cost efficiency, with less emphasis on energy consumption or sustainability. Traditional session routing approaches do not explicitly consider energy usage when determining routes, which can lead to less optimized energy consumption. While many networks provision resources to ensure reliability and performance, this can sometimes lead to unnecessary use of energy, particularly during periods of low demand when infrastructure such as data centers and routers remain active. As a result, communication networks may end up consuming significant amounts of energy. Furthermore, while VOIP/IP Telephony (IPT) and cloud-based collaboration systems have streamlined operations and reduced physical infrastructure footprint, there are opportunities for improving energy efficiency or reducing environmental impact from the collaboration sessions that are placed over the top of the network or collaboration infrastructure.

### SUMMARY OF THE DISCLOSURE

Systems and methods for facilitating sustainability-aware collaboration session routing in accordance with embodiments of the disclosure are described herein.

In many embodiments, a device comprises a processor and a memory communicatively coupled to the processor. The memory comprises a session control logic that is configured to receive one or more attributes of a plurality of network devices, determine a set of sustainability scores for the plurality of network devices based on the one or more attributes, select, from the plurality of network devices, a target network device based on the set of sustainability scores, and direct a collaboration session activity to the target network device.

In a variety of embodiments, the one or more attributes comprise at least one of: an operational status, a utilization status, an energy consumed status, an energy source status, a grid risk status, a carbon footprint status, a water usage effectiveness status, or a carbon usage effectiveness status.

In a number of embodiments, the one or more attributes comprise at least one of a geographic carbon intensity status or a power usage effectiveness status.

In further embodiments, the one or more attributes comprise one of a set of sustainability attributes or a combination of the set of sustainability attributes and a set of non-sustainability attributes.

In several embodiments, the one or more attributes are received from the plurality of network devices.

In additional embodiments, the one or more attributes are received from the plurality of network devices in at least one of respective collaboration session messages or respective keep alive pings.

In more embodiments, the one or more attributes are received from a sustainability controller in communication with the plurality of network devices.

In numerous embodiments, the session control logic is further configured to receive an incoming collaboration session from an endpoint device.

In various embodiments, directing the collaboration session activity to the target network device comprises routing the incoming collaboration session to the target network device.

In one or more embodiments, the session control logic is further configured to receive one or more updated attributes from the target network device at termination of the incoming collaboration session, and determine a new sustainability score for the target network device based on the one or more updated attributes.

In yet more embodiments, the session control logic is further configured to determine whether the incoming collaboration session routed to the target network device is connected successfully, and select, from the plurality of network devices, a new target device in response to determining that the incoming collaboration session routed to the target network device has failed. The new target device is selected based on the set of sustainability scores. The session control logic is further configured to re-route the incoming collaboration session to the new target network device.

In still more embodiments, to select the target network device, the session control logic is further configured to identify one or more rules associated with the incoming collaboration session, and determine a set of network devices of the plurality of network devices that satisfies the one or more rules. The target network device corresponds to one of the set of network devices selected based on the set of sustainability scores.

In still yet more embodiments, directing the collaboration session activity to the target network device comprises routing collaboration session control for the incoming collaboration session to the target network device.

In many further embodiments, directing the collaboration session activity to the target network device comprises directing a device registration request to the target network device.

In many additional embodiments, the set of sustainability scores is determined based on a sustainability policy defining respective weights for the one or more attributes.

In many more embodiments, the session control logic is further configured to sort the plurality of network devices in an order based on the set of sustainability scores.

In several additional embodiments, the session control logic is further configured to receive one or more new attributes of one or more network devices of the plurality of network devices, and update one or more sustainability scores of the set of sustainability scores based on the one or more new attributes.

In numerous additional embodiments, the determination of the set of sustainability scores is further based on a machine learning model.

In several more embodiments, a network device comprises a processor and a memory communicatively coupled to the processor. The memory comprises a session control logic that is configured to monitor a set of sustainability attributes associated with the network device, transmit the set of sustainability attributes, and receive at least one of an incoming collaboration session, a session control request, or a device registration request in response to a sustainability score, derived from the transmitted set of sustainability attributes, being optimal in comparison to respective sustainability scores of one or more peer network devices.

In various additional embodiments, a method comprises receiving one or more attributes of a plurality of network devices, determining a set of sustainability scores for the plurality of network devices based on the one or more attributes, selecting, from the plurality of network devices, a target network device based on the set of sustainability scores, and directing a collaboration session activity to the target network device.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual network diagram of a communication system that implements a session control logic in accordance with various embodiments of the disclosure;

FIG. 2 is a schematic block diagram of an example communication network implementing sustainability-aware collaboration session activity routing in accordance with various embodiments of the disclosure;

FIG. 3 is a schematic flow diagram that illustrates provision of one or more attributes of a gateway to a communication management device for facilitating sustainability-aware collaboration session activity routing in accordance with various embodiments of the disclosure;

FIG. 4 is a schematic flow diagram that illustrates provision of one or more attributes of a gateway to a communication management device for facilitating sustainability-aware collaboration session activity routing in accordance with various embodiments of the disclosure;

FIG. 5 is a schematic block diagram that illustrates provision of one or more attributes of a network device by a sustainability controller to a communication management device for facilitating sustainability-aware collaboration session activity routing in accordance with various embodiments of the disclosure;

FIG. 6 is a schematic communication flow diagram that illustrates a sustainability-aware device registration process in accordance with various embodiments of the disclosure;

FIG. 7 is a schematic communication flow diagram that illustrates a sustainability aware dynamic device registration process in accordance with various embodiments of the disclosure;

FIG. 8 a conceptual illustration of an example of sustainability-aware collaboration session activity routing system in accordance with various embodiments of the disclosure;

FIG. 9 is a diagram depicting various subsets of artificial intelligence in accordance with various embodiments of the disclosure;

FIG. 10 illustrates different methods of machine-based learning in accordance with various embodiments of the disclosure;

FIG. 11 is a machine learning lifecycle in accordance with various embodiments of the disclosure;

FIG. 12 is an exemplary neural network in accordance with various embodiments of the disclosure;

FIG. 13 is a flowchart depicting a process for directing collaboration session activities based on sustainability awareness in accordance with various embodiments of the disclosure;

FIG. 14 is a flowchart depicting a process for directing a collaboration session activity to a network device based on sustainability awareness in accordance with various embodiments of the disclosure;

FIG. 15 is a flowchart depicting a process for routing an incoming collaboration session to a network device based on sustainability awareness in accordance with various embodiments of the disclosure;

FIG. 16 is a flowchart depicting a process for updating sustainability scores in accordance with various embodiments of the disclosure;

FIG. 17 is a flowchart depicting a process for transmitting a set of sustainability attributes by a network device in accordance with various embodiments of the disclosure; and

FIG. 18 is a conceptual block diagram of a device suitable for configuration with a session control logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein to facilitate sustainability-aware collaboration session activity routing in communication networks. Session routing is a fundamental part of network communication, ensuring that sessions are directed from the origin to the destination through an optimal path. Circuit-switched network is the earliest form of call routing, utilized primarily in traditional Public Switched Telephone Networks (PSTN). As networks evolved, packet-switched systems, particularly Voice over internet protocol (VOIP), became prevalent. VoIP systems break up voice data into packets and route them across the Internet or private networks. However, modern communication systems have introduced dynamic session routing, where routing decisions are made in real-time based on network conditions. This approach is utilized to optimize the session quality, reduce latency, and minimize costs. Algorithms may choose routes based on factors such as bandwidth availability, network congestion, and geographical proximity of data centers. Dynamic session routing systems, further utilize collaboration session routing that directs calls, video conferences, or other forms of communication sessions through collaboration platforms. Unlike traditional session routing, which typically focuses on voice communication, collaboration session routing involves directing data traffic efficiently between users, devices, or applications during activities like video conferencing, shared editing, or virtual meetings. It ensures minimal latency, high reliability, and optimal performance by leveraging technologies. Modern collaboration session platforms use Selective Forwarding Units (SFUs) to optimize media streams, and cloud infrastructure with load balancing to enhance scalability and fault tolerance. These technologies work together to maintain seamless, secure, and real-time collaboration across varied networks and devices.

Despite these advancements in session routing technology, session routing has been optimized mainly for cost and performance metrics, with less emphasis on sustainability or environmental impact. Traditional session routing systems may not explicitly consider energy usage as a factor when deciding on routes, which can lead less optimized energy consumption. While many networks provision resources to ensure reliability and performance, this can lead to unnecessary use of energy. For example, when network demand is low, infrastructures such as data centers and routers typically remain active. Most dynamic routing algorithms are primarily designed to reduce latency or optimize operational costs, but they often fail to take environmental factors into consideration in their routing decisions. For example, when selecting a path, these algorithms may not distinguish between data centers powered by coal and those using renewable energy sources like solar or wind energy.

Although certain session routing technologies aim to enhance sustainability in collaboration architecture by utilizing VoIP/IP Telephony “IPT” instead of traditional Private Branch Exchange (PBX) systems to streamline operations and reduce energy consumption, this shift also presents new challenges. While VoIP systems are generally more efficient, they still depend on data centers, which can consume notable amounts of energy, particularly when not powered by renewable sources. Similarly, moving collaboration session systems to the cloud offers improved economies of scale for energy usage. Furthermore, while VOIP/IP Telephony (IPT) and cloud-based collaboration session systems have streamlined operations and reduced physical infrastructure footprints, there are opportunities for further improvements in energy efficiency through more sustainability-aware routing mechanisms.

This is where sustainability-aware collaboration session activity routing disclosed in the present disclosure plays an important role, by incorporating energy efficiency and carbon reduction into the core of routing algorithms, aligning communication systems with global sustainability goals. A network device (e.g., a communication management device, a collaboration device, a media transaction server, a media termination server, a software conference bridge, a media call processing server, or device registration server, or the like) may be configured to facilitate sustainability-aware dynamic collaboration session routing. Hereinafter, the network device is referred to as the “communication management device”. The communication management device may be an integral component of a data center and may be communicatively coupled to a plurality of endpoint devices that initiate and participate in communication and collaboration. The “endpoint devices” may refer to user devices that may include, for example, smartphones, computers, laptop, tablets, smartwatches, or the like that individuals use to access services, applications, or data in a network. The communication management device may be further communicatively coupled to a plurality of network devices such as gateway devices. The gateway devices may serve as intermediaries that manage and direct communication traffic between different network types or protocols, such as VoIP networks and traditional PSTN systems. Further, the gateway devices can facilitate conversion of voice, video, and data streams between disparate systems, enabling seamless interaction across different communication platforms.

In many embodiments, the communication management device may include a processor and a memory communicatively coupled to the processor. The memory may include a session control logic. In other embodiments, the session control logic can also be external to the communication management device. The communication management device may perform collaboration session routing that may include call routing, video stream routing, file transfer, file exchange, or the like. The communication management device may be configured to receive one or more attributes of the plurality of network devices. In one or more embodiments, the one or more attributes may be received from the plurality of network devices in at least one of respective collaboration session messages or respective keep alive pings. “Collaboration session messages” or “keep-alive pings” may refer to mechanisms used in communication networks to maintain and manage active sessions, ensuring proper connectivity between devices during a call or data session. The collaboration session messages may refer to signaling messages exchanged between network devices (such as servers, gateway devices, or endpoint devices) when a call or session is taking place or is ending. For example, in protocols like Session Initiation Protocol (SIP), the collaboration session messages include, for example “BYE” (e.g., BYE may be sent by network devices to end a session), “ACK” (e.g., ACK may be sent for acknowledging the end of the session after receiving a BYE message), or “CANCEL” (e.g., CANCEL may be sent to end an incomplete session before it is connected). The keep-alive pings may refer to periodic small signaling messages sent between devices to maintain an active session or confirm that both ends of a connection are still reachable. Protocols often used for keep-alive may include, for example, “SIP OPTIONS” or “REGISTER” or “INVITE” messages (e.g., SIP OPTIONS or REGISTER messages may be sent to verify the status of a remote endpoint in a SIP-based session), Packet Internet Groper “PING”, Internet Control Message Protocol “ICMP” messages (e.g., PING or ICMP messages may be sent at the network layer to ensure that devices remain reachable), or the like. In additional embodiments, the one or more attributes may be received from a sustainability controller in communication with the plurality of network devices.

The one or more attributes may include one of a set of sustainability attributes or a combination of the set of sustainability attributes and a set of non-sustainability attributes. The set of sustainability attributes may include sustainability parameters associated with key performance indices (KPIs) of the plurality of network devices, for example an operational status, a utilization status, an energy consumed status, an energy source status, a grid risk status, a carbon footprint status, geographic carbon intensity status, a power usage effectiveness status, a water usage effectiveness status, or a carbon usage effectiveness status of a network device (e.g., a gateway device). In an example, the operational status of a gateway device may be indicative of whether it is functioning correctly. The utilization status may show the percentage of the capacity of the gateway device being used. Further, the energy consumed status may be indicative of the amount of energy the gateway device has consumed, while the energy source status may provide identification of whether the energy comes from renewable or non-renewable sources. Furthermore, the grid risk status may reflect potential vulnerabilities in the power supply, and the carbon footprint status may be indicative of emissions associated with the operation of the gateway device. The geographic carbon intensity status may indicate the carbon emissions per unit of energy in its region, while the power usage effectiveness status may provide assessment of the efficiency of its energy use. The set of non-sustainability attributes may include, for example, latency, bandwidth, packet loss rate, uptime, jitter, or other performance related parameters of the network device.

In a variety of embodiments, the communication management device may be configured to determine a set of sustainability scores for the plurality of network devices based on the one or more attributes. In other words, the communication management device may determine a sustainability score for each network device based on corresponding one or more attributes. The set of sustainability scores may also be referred to as “green scores”. In some more embodiments, the set of sustainability scores may be further determined based on factors such as location-specific carbon limits or carbon intensity, power quality, and newer, more energy-efficient hardware in the plurality of network devices. Additionally, sustainability ratings of service providers, such as Environmental, Social, and Governance (ESG) performance, may also influence the determination of the set of sustainability scores.

In many more embodiments, the set of sustainability scores may be based on a sustainability policy that may assign specific weights to the one or more attributes. In other words, the sustainability policy may outline how much importance or influence each attribute, such as energy consumption, carbon footprint, geographic carbon intensity, etc., has in determining a sustainability score. By applying the weighted attributes, the communication management device can more accurately assess the environmental impact of its operations and make informed decisions that prioritize sustainability, such as choosing more energy-efficient resources or reducing carbon emissions.

In a number of embodiments, the communication management device may select, from the plurality of network devices, a target network device based on the set of sustainability scores. For example, the communication management device may compare the set of sustainability scores across multiple gateway devices and may sort the gateway devices in an order based on the set of sustainability scores. In several more embodiments, the communication management device may choose the target network device that may align best with sustainability goals, such as reducing energy use or minimizing carbon emissions.

In still more embodiments, the selection of the target network device by the communication management device may be further based on one or more rules. The one or more rules may refer to predefined policies and conditions that govern how collaboration sessions may be routed and what resources are available to users. The one or more rules may include, for example, a dialed number, a class of service (CoS), or the like. The dialed number may determine how the communication management device may handle the collaboration session based on a destination number (e.g., local, long-distance, or international sessions) and applies specific routing logic accordingly. CoS may refer to the permissions and restrictions for users, determining what kind of sessions the communication management device are allowed to make (e.g., local only, international, emergency sessions) and which gateway devices the communication management device can utilize. Thus, in yet more embodiments, the communication management device may identify one or more rules associated with an incoming collaboration session and determine a set of network devices of the plurality of network devices that satisfies the one or more rules. The set of network devices may form a route group. For example, a route group may refer to a set of homogeneous network devices that can all route the same collaboration session similarly. In other words, network devices are placed in a route group for redundancy and load balancing. In further additional embodiments, the target network device may correspond to one of the set of network devices selected based on the set of sustainability scores. Further, the communication management device may direct a collaboration session activity to the target network device.

In several more embodiments, the communication management device may determine a plurality of route groups based on the one or more rules and rank the plurality of route groups in progressively decreasing order based on their capability to handle the same incoming collaboration session. The plurality of route groups may collectively form a routing list. A “routing list” may correspond to a sequential list of route groups, allowing for preferential treatment of what route group to be selected and in what order for collaboration session activity routing.

In more embodiments, directing the collaboration session activity to the target network device may comprise routing an incoming collaboration session to the target network device. For example, the communication management device may receive an incoming collaboration session from an endpoint device and select the target network device (e.g., a target gateway device) to connect the collaboration session. Upon selection, the communication management device may be configured to route the incoming collaboration session to the target network device.

In further embodiments, the communication management device may be configured to determine whether the incoming collaboration session routed to the target network device is completed successfully. In response to determining that the incoming collaboration session routed to the target network device has failed, the communication management device may be configured to select, from the plurality of network devices, a new target network device based on the set of sustainability scores. For example, in the route group, the communication management device may select another gateway device that has the next best sustainability score. In still further embodiments, the communication management device may re-route the incoming collaboration session to the new target gateway device. In a scenario, if the entire route group is exhausted and the incoming collaboration session is yet not completed, the communication management device may move to the next route group for selection of the target network device, until such target network device is selected that results successful completion of the incoming collaboration session.

In numerous embodiments, the communication management device may be further configured to receive one or more updated attributes from the target network device (or the new target network device) at the termination of the incoming collaboration session. In other words, after the collaboration session ends, the target network device may send updated attributes to the communication management device. In other embodiments, the communication management device may be further configured to receive one or more updated attributes from the target network device (or the new target network device) at an initiation of the incoming collaboration session or midway while an ongoing collaboration session is taking place. The updated attributes may include, for example, resource utilization during the collaboration session (e.g., CPU or bandwidth usage), energy consumption, or the overall performance metrics during the collaboration session. In numerous additional embodiments, based on the one or more updated attributes, the communication management device may determine a new sustainability score for the target network device.

In still additional embodiments, the communication management device may direct the collaboration session activity to the target network device by routing collaboration session control for the incoming collaboration session to the target network device. Example of various collaboration session control operations may include collaboration session authentication and authorization, Quality of Service management, session feature management such as session hold, transfer, forwarding, session transaction management, session termination management, or the like. In still yet more embodiments, the communication management device may be configured to route collaboration session activities to network devices located in geographical regions with lower carbon intensity, helping to minimize the environmental impact by leveraging areas with cleaner energy sources.

In several embodiments, directing the collaboration session activity to the target network device may include routing a device registration request to the target network device. For example, when an endpoint device attempts to register or authenticate itself on the network, the communication management device may guide the registration process to the target network device selected based on the set of sustainability scores. For example, a first network device (e.g., a registration server) may receive a device registration request from an endpoint device. In a scenario where a second network device exists which has a better sustainability score than the first network device, the communication management device may select the second network device for device registration process. Based on the selection of the second network device for the device registration process, the first network device may transmit a message to the endpoint device indicating the endpoint device to utilize the selected second network device for the device registration. Based on such a message, the endpoint device may re-attempt to register or authenticate itself with the second network device.

In numerous additional embodiments, the communication management device may be equipped with an artificial intelligence (AI) model or a machine learning (ML) model. The determination of routing decisions to optimize aggregate sustainability scores may be based on the AI model and/or the ML model. AI may be typically understood in the art to be the development of machines and algorithms that mimic human intelligence, for example, by optimizing actions to achieve certain goals. At its core, AI often involves designing algorithms and models that mimic cognitive functions, such as learning, reasoning, problem-solving, perception, and even language understanding. Unlike traditional computer programs that follow a fixed set of instructions, AI systems have the ability to adapt, improve, and make decisions based on input data and environmental interactions.

In further additional embodiments, each network device of the plurality of network devices may be configured to monitor a set of sustainability attributes associated therewith, for example, during an ongoing collaboration session activity. The network device may transmit the set of sustainability attributes to the communication management device. The communication management device may in turn derive a sustainability score for the network device. The network device may be configured to receive at least one of an incoming collaboration session, a session control request, or a device registration request in response to the sustainability score being optimal in comparison to respective sustainability scores of one or more peer network devices. The network device may then route the incoming collaboration session to a destination network (for example, IP or PSTN).

In many additional embodiments, the sustainability score of the network device may be compared with a corresponding sustainability threshold range by the communication management device. The network device may be declared as sustainable if the sustainability score falls within the sustainability threshold range. The network device may be declared unsustainable if the sustainability score falls outside the sustainability threshold range. Thus, the communication management device may be configured to redirect collaboration sessions, session control, or device registrations from unsustainable network devices to sustainable network devices. Additionally, unsustainable network devices may receive a power down signal from the communication management device to enable powering down of the unsustainable network devices that may no longer be needed.

Thus, the devices and methods facilitate sustainability-aware collaboration session activity routing that considers sustainability impacts in making routing decisions, improves energy optimization, and reduces environmental impact. By steering incoming collaboration sessions, session control, message, file sharing, or device registrations to more sustainable network devices, energy efficiency is enhanced. Additionally, routing sessions through regions with lower carbon intensity may reduce the overall carbon footprint, helping organizations meet sustainability targets and regulatory requirements. Thus, these benefits can be applied across session and multimedia control protocols, optimizing the sustainability and performance of systems like media servers, collaboration gateways, and device registration processes. Integrating sustainability awareness is not limited to collaboration session routing and control activities, such intelligence can be extended to other areas as well. For example, virtual meetings can be recommended during times of the day when carbon emission intensity is at its lowest, reducing the environmental impact. Outbound dialer campaigns can be scheduled similarly for optimizing carbon efficiency. Additionally, media resources such as conference bridges and transcoders can be selected based on their sustainability scores.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit. Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data. Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

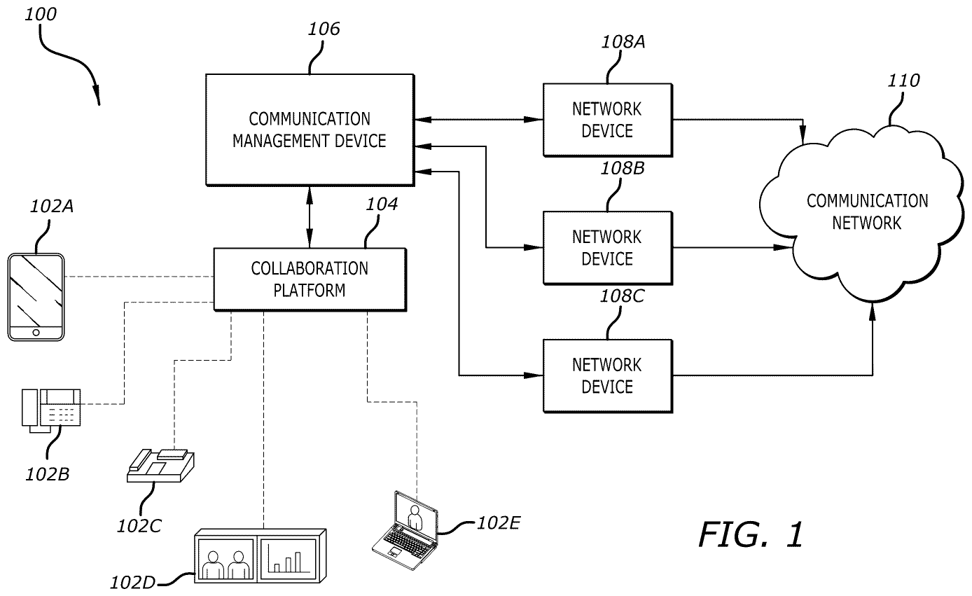

Referring to FIG. 1, a conceptual network diagram of a communication system 100 that implements a session control logic in accordance with various embodiments of the disclosure is shown. The session control logic can include various hardware and/or software deployments and can be configured in a variety of ways. In some non-limiting examples, the session control logic can be configured as a standalone device, exist as a logic within a network device, be distributed among various network devices operating in tandem, or remotely operated as part of a cloud-based network management tool. The embodiments shown in FIG. 1 illustrate the communication system 100 comprising various network devices that can implement the session control logic for directing a collaboration session activity.

In a number of embodiments, the communication system 100 may include a plurality of end-user devices 102A, 102B, 102C, 102D, 102E (collectively referred to as “the end-user devices 102A-102E”) having the ability to establish communication sessions between each other using a communication network 110. The end-user devices 102A-102E may be utilized to initiate or receive communication over the communication network 110. The term “end-user device” may encompass a myriad of potential devices and infrastructure that may benefit from the operations of the communication system 100. The end-user devices 102A-102E may include a Personal Digital Assistant (PDA), a cellular telephone, a standard telephone that may be coupled to a personal computer, an Internet Protocol (IP) telephone, a personal computer, a laptop computer, a mobile telephone, Voice over internet protocol (VOIP) phones, tablets, smartphones, unified communications (UC) endpoints (e.g., video conferencing systems), or any other suitable device or element (or any appropriate combination of these elements) that is operable to receive data or information over the communication network 110. FIG. 1 illustrates only a set of example devices that may be utilized within the communication system 100. The present disclosure is replete with numerous alternatives that could be utilized to facilitate the operations of the communication system 100. Each end-user device 102A-102E may be connected to the communication network 110 and can either initiate or receive communication through voice, video, or messaging. The end-user devices 102A-102E typically utilize communication protocols such as Session Initiation Protocol (SIP) or Web Real-Time Communication (WebRTC) to establish connections.

The end-user devices 102A-102E may be communicatively coupled to a collaboration platform 104 that may facilitate communication, information sharing, among the end-user devices 102A-102E, regardless of their location. The collaboration platform 104 may be a centralized system that enables unified communication and collaboration services, such as, Microsoft Teams®, Cisco® Webex®, Zoom®, or the like. In many embodiments, the collaboration platform 104 may include cloud-based centralized management servers connected to the end-user devices 102A-102E. The collaboration platform 104 may handle session setup, real-time messaging, file sharing, and video conferencing among the end-user devices 102A-102E. The collaboration platform 104 may further provide a user interface for managing and scheduling meetings, making sessions, and collaboration. The collaboration platform 104 may also handle user registration, presence management, session initiation, and collaboration sessions (voice, video, messaging) by interacting with a communication management device 106.

In a variety of embodiments, the communication management device 106 (also referred to as “a session routing controller”) may be responsible for managing session activities within the communication system 100. The communication management device 106 may correspond to any network resource that can run an associated software stack for collaboration session activity routing. For example, the communication management device 106 can be a unified communications manager, a gateway controller, a collaboration gateway, a media transaction server, a media termination server, a media collaboration session processing server, device registration server, or the like.

In one or more embodiments, the communication management device 106 may be a proxy server operable to send registrations, invitations to sessions, and other requests. In more embodiments, the communication management device 106 may be any suitable component (e.g. a switch, a router, a bridge, a state machine, a processor, a server, etc.) that is operable to interface with endpoints/end-user devices. In many more embodiments, software and/or hardware may reside in the communication management device 106 to facilitate sustainability-aware collaboration session routing. Further, the communication management device 106 may be equipped with or include any suitable component, device, application specific integrated circuit (ASIC), processor, microprocessor, algorithm, read only memory (ROM) element, random access memory (RAM) element, erasable programmable ROM (EPROM), electrically erasable programmable ROM (EEPROM), field programmable gate array (FPGA), or any other suitable element or object that is operable to facilitate the operations thereof.

In numerous embodiments, the communication management device 106 may direct collaboration session activities, such as incoming collaboration sessions, session control, device registrations, etc. to a plurality of network devices 108A, 108B, 108C. Examples of the plurality of network devices 108A, 108B, 108C may include gateway devices, registration servers, or the like. The communication management device 106 may utilize various protocols, for example, SIP for session signaling, Real-Time Transport Protocol (RTP) for media delivery, or the like. The communication management device 106 can also handle Web real time communication “WebRTC” communications for browser-based collaboration. For example, the communication management device 106 may facilitate connection between the end-user device 102B, which uses H.323 protocol, and another end-user device 102A which uses SIP protocol. Further, the communication management device 106 may monitor the end-user devices 102A-102E and transmit information regarding the status of various end-user devices and/or sessions to appropriate entities within the communication system 100. The communication management device 106 may further include centralized management servers that can be configured to execute the session control logic to route collaboration sessions based on sustainability scores, energy efficiency, server utilization, and geographic carbon intensity of the plurality of network devices 108A, 108B, 108C. Hereinafter, the plurality of network devices 108A, 108B, 108C are collectively referred to as “the network devices 108A-108C”).

In one or more embodiments, the network devices 108A-108C may serve as intermediaries that enable communication between different network types and protocols. For example, the network devices 108A-108C can translate communication protocols such as SIP to PSTN protocols, enabling collaboration sessions between VoIP systems and traditional telephony systems. The network devices 108A-108C may provide a bridge between the collaboration platform 104 and the external communication network 110. The network devices 108A-108C may include various types of gateway devices such as VOIP gateways, media gateways, Session Border Controllers (SBCs), or the like. A VoIP gateway may facilitate conversion of voice data between VoIP networks and traditional telephone networks (e.g., PSTN). A media gateway may convert media streams (audio/video) between different formats, ensuring compatibility between VoIP endpoints and legacy systems. An SBC may handle the security, session control, and routing of voice traffic, ensuring secure and seamless communication between different domains. Incoming collaboration sessions from the end-user devices 102A-102E can be routed through the network devices 108A-108C to/from the communication network 110, allowing communication between traditional and IP-based networks. The network devices 108A-108C can further include various types of registration servers.

The communication network 110 can include wired networks or wireless networks. In a variety of embodiments, the communication system 100 may include remote networks, such as, but not limited to a deployed network. The communication network 110 may be implemented as a local area network (LAN), wide area network (WAN), global distributed network such as the Internet, an intranet, an extranet, or any other form of wireless or wireline communication network. In addition, the communication system 100 in accordance with various embodiments may include any number of collaboration platforms 104.

In an example embodiment, the communication network 110 can be a packet switched networked (e.g., Public Switched Telephone Network “PSTN”). Accordingly, communication in the communication network 110 may occur using packets, cells, frames, or other portions of information. The communication network 110 may include a plurality of segments that couple the end-user devices 102A-102E with the communication platform 104 and the network devices 108A-108C. The segments may include a broadband access link, digital subscriber (DSL) link, a T1 link, a fiber optic link, and/or a wireless link.

In various embodiments, the communication network 110 may be functional to employ voice communication protocols that allow addressing or identification of the end-user devices 102A-102E, the network devices 108A-108C, the collaboration platform 104, and/or the communication management device 106 coupled to the communication network 110. In the illustrated embodiment, the end-user devices 102A-102E and the collaboration platform 104 may include IP telephony capabilities allowing them to participate in and/or monitor instant messaging, audio, video, and other multimedia communication sessions.

In still more embodiments, the communication system 100 may transmit data using SIP, which is an application layer control protocol and can establish, modify, and terminate multimedia sessions (conferences) such as Internet telephony calls. SIP may work independently of underlying transport protocols and without dependency on the type of session that is being established. Further, SIP may be utilized in creating a shared line environment in which several IP phones may share a single line. A communication device that is part of a shared line may receive status updates, sometimes referred to as remote state notifications, that let all the devices sharing the line know what all the other devices are doing. It should be noted that the SIP control protocol is used by way of example and not meant to limit the scope of the present disclosure.

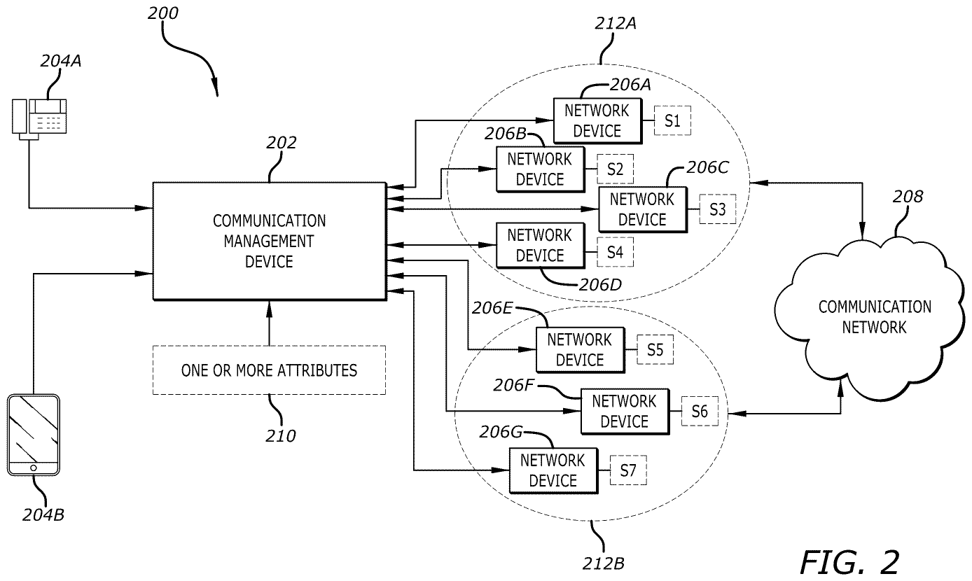

Although a specific embodiment for a conceptual network diagram of various environments that implement a communication system that implements a session control logic suitable for carrying out the various steps, processes, methods, and operations described herein is discussed with respect to FIG. 1, any of a variety of systems and/or processes may be utilized in accordance with embodiments of the disclosure. For example, the illustrated embodiment includes a single communication network 110, but the communication network 110 is intended to represent any number, type, size, or group of communication networks. Further, the term “communication network” should be interpreted as generally defining any network capable of transmitting audio and/or video telecommunication signals, data, and/or messages, including signals, data, or messages transmitted through text chat, instant messaging, and e-mail. The elements depicted in FIG. 1 may also be interchangeable with other elements of FIGS. 2-18 as required to realize a particularly desired embodiment.

Referring to FIG. 2, a schematic block diagram of an example communication network 200 implementing sustainability-aware collaboration session activity routing in accordance with various embodiments of the disclosure is shown. The communication network 200 can refer to a high-speed, high-bandwidth interconnect system that enables multiple network devices to communicate with each other efficiently and reliably. The communication network 200 may conform to a network topology defined to provide a sustainability aware infrastructure for data center, cloud environments, or other network environments. The communication network 200 may correspond to a wireless or wired network or a combination of both for facilitating sustainability-aware collaboration session activity routing.

In many embodiments, the communication network 200 may include a communication management device 202 that facilitates dynamic session routing based on sustainability awareness. The communication management device 202 may be a device configured with a sustainability-aware session control logic that incorporates energy efficiency and carbon reduction into the core of routing algorithms, aligning telecommunications with global sustainability goals. Various examples of the communication management device 202 may include, but are not limited to, a server, a device controller, a session controller, a collaboration device, a network device, a media transaction server, a media termination server, a software conference bridge, a media session processing server, device registration server, a unified communications manager, or the like.

The communication management device 202 may be an integral component of a data center and may be communicatively coupled to a plurality of end-user devices (for example, a first end-user device 204A and a second end-user device 204B) that initiate and participate in communication and collaboration. The “end-user devices” may refer to devices, for example, Personal Digital Assistant (PDA), a cellular telephone, a standard telephone that may be coupled to a personal computer, an Internet Protocol (IP) telephone, a personal computer, a laptop computer, a mobile telephone, Voice over internet protocol (VOIP) phones, tablets, smartphones, UC endpoints, or any other suitable devices or elements that individuals use to access services, applications, or data in a network. Further, the communication management device 202 may be communicatively coupled to a plurality of network devices 206A-206G (for example, a plurality of gateways). The plurality of network devices may serve as intermediaries that manage and direct communication traffic within a communication network 208. The communication network 208 may include different network types or protocols, such as VoIP networks, PSTN networks, or the like. The plurality of network devices may facilitate the conversion of voice, video, and data streams between disparate systems, enabling seamless interaction across the communication network 208. For the sake of brevity and in a non-limiting example, only two end-user devices 204A and 204B and seven network devices 206A-206G are shown in FIG. 2, whereas a communication network can include any number of end-user devices and network devices spread across different geographical regions.

In one or more embodiments, the communication management device 202 may include a processor and a memory communicatively coupled to the processor. The memory may include the session control logic or the session control logic can be embodied as a standalone component, for example, a dedicated a controller, within the communication management device 202. Alternatively, the session control logic may be implemented external to the communication management device 202. The communication management device 202 may be configured to implement sustainability-aware collaboration session activity routing by way of the session control logic.

In many more embodiments, the communication management device 202 may receive one or more attributes 210 of the plurality of network devices 206A-206G. In various embodiments, the one or more attributes 210 may be received from the plurality of network devices 206A-206G in at least one of respective collaboration session messages or respective keep alive pings. The collaboration session messages, for example, session termination messages, session transaction messages, or the like, may refer to signaling messages exchanged between network devices (such as servers, gateways, or end-user devices) when a session is initiated, during the session, or when the session is terminated. The session termination exchange messages may indicate that the session is being terminated and network resources utilized for the session are being released. For example, in protocols such as SIP, the session termination exchange messages may include “BYE”, “ACK”, “CANCEL” messages. The BYE message may be sent by a network device to end a session. The ACK message may be sent to acknowledge the end of the session after receiving a BYE message, and the CANCEL message may be sent to end an incomplete or ringing session before it is answered. Further, the collaboration session messages may include “INVITE” that may be utilized to initiate a request to start a real-time communication session, such as a voice or video call, typically using protocols like SIP. The “keep-alive pings” may refer to periodic signaling messages exchanged between network devices to maintain an active session or confirm that both ends of a connection are still reachable. Protocols often used for keep-alive may include, for example, SIP OPTIONS or REGISTER messages, Packet Internet Groper “PING” or Internet Control Message Protocol “ICMP” messages, or the like. SIP OPTIONS or REGISTER messages may be exchanged to verify the status of a network device in an SIP-based session. Further, the PING or ICMP messages may be sent at network layer to ensure that the network devices remain reachable. In many additional embodiments, the one or more attributes 210 may be received from a sustainability controller in communication with the plurality of network devices 206A-206G.

In yet various embodiments, the one or more attributes 210 may include a set of sustainability attributes. In still various embodiments, the one or more attributes 210 may include a combination of the set of sustainability attributes and a set of non-sustainability attributes. The set of sustainability attributes of a network device (for example, a gateway) may include factors such as an operational status, a utilization rate, energy consumption, an energy source, a grid reliability, a carbon footprint, a regional carbon intensity, a water usage effectiveness, a carbon usage effectiveness, or a power usage effectiveness of the network device. In an example, the operational status may indicate whether the network device is working properly, while the utilization rate may show how much of the capacity of the network device is being utilized. The energy consumption status may reflect the amount of energy the network device has used, and the energy source status identifies whether the energy comes from renewable or non-renewable sources. The grid risk status may highlight potential power supply vulnerabilities of the network device. Further, the carbon footprint status may indicate emissions produced by the network device's operation, and the geographic carbon intensity shows the emissions per energy unit in the region the network device is located. Further, the power usage effectiveness status may measure the efficiency of energy use of the network device. Non-sustainability attributes, on the other hand, may include factors, for example, latency, bandwidth, packet loss, uptime, and jitter, focusing on performance of the network device instead of the environmental impact.

In a variety of embodiments, the communication management device 202 may be configured to determine a set of sustainability scores for the plurality of network devices 206A-206G based on the received one or more attributes 210. In other words, the communication management device 202 may determine a sustainability score for each network device 206A-206G based on the one or more attributes 210 associated with the gateway device. The set of sustainability scores may also be referred to as “green scores”. In example, a sustainability score of the sustainability scores may be a composite score that is based on a combination of a carbon footprint score, an energy efficiency score, a renewable energy use score, an energy consumption score, a geographic carbon intensity score, a grid dependency risk score, a water usage efficiency score, a waste reduction score, or the like.

In an example scenario, the set of sustainability scores for the plurality of network devices 206A-206G may be determined based on a sustainability policy that assigns specific weights to the one or more attributes 210. Each of the one or more attributes 210 may be assigned a weight based on its importance and impact on sustainability. In a number of embodiments, the weights may be assigned based on one or more business goals or environmental targets an enterprise is attempting to achieve. For example, if a business goal is to route session activities over resources that are in a geographical area with less carbon intensity, attributes such as the carbon footprint and the regional carbon intensity may have higher weights in comparison to other attributes such as energy consumption and utilization rate. Similarly, if a business goal is to maximize utilization rate of network devices with low carbon footprint, attributes such as the carbon footprint and the utilization rate may have higher weights in comparison to other attributes such as regional carbon intensity. In an example, a sustainability score of a first network device 206A may correspond to a weighted sum of the values of the one or more attributes 210 of the first network device 206A. In another example, a sustainability score of the first network device 206A may correspond to a weighted average of the values of the one or more attributes 210 of the first network device 206A. The communication management device 202 can utilize any statistical aggregation technique to determine the set of sustainability scores once the values of the one or more attributes 210 are received for the plurality of network devices 206A-206G. Determination of the set of sustainability scores based on the sustainability policy may allow customization according to changing business needs.

In another example scenario, the set of sustainability scores for the plurality of network devices 206A-206G may be determined based on a trained machine learning model that takes the values of the one or more attributes 210 as input. For example, a training dataset of various gateway devices with known attributes and sustainability scores can be utilized to train the machine learning model. The machine learning model may identify patterns and relationships between the one or more attributes 210 and their impact on sustainability, allowing the machine learning model to predict sustainability scores for the plurality of network devices 206A-206G. The utilization of machine learning model may allow the communication management device 202 to automatically derive complex, non-linear relationships between the one or more attributes 210 and sustainability impact.

In the example embodiment shown in FIG. 2, the communication management device 202 may determine the set of sustainability scores as {S1, S2, S3, S4, S5, S6, S7} for the plurality of network devices 206A-206G, respectively. In more embodiments, the communication management device 202 may not receive values of the one or more attributes 210 for a network device. In such an embodiment, the communication management device 202 may be unable to determine a sustainability score for such network device.

Upon determining the set of sustainability scores, the communication management device 202 may be configured to compare the set of sustainability scores and sort the plurality of network devices 206A-206G in an order based on the set of sustainability scores. In an example embodiment, the plurality of network devices 206A-206G may be sorted in a descending order of their sustainability scores as follows: the first network device 206A with the sustainability score S1, a second network device 206B with the sustainability score S2, a third network device 206C with the sustainability score S3, a fourth network device 206D with the sustainability score S4, a fifth network device 206E with score the sustainability S5, a sixth network device 206F with the sustainability score S6, and a seventh network device 206G with the sustainability score S7. Thus, indicating that the sustainability score S1 is the highest while the sustainability score S7 is the lowest.

Due to absence of the set of sustainability scores in traditional session activity routing, session controllers typically follow performance-based rules for routing session activities, often using methods like round-robin distribution or a static preference for one gateway device over another. This approach works well for redundancy and load balancing but may not account for differences in sustainability impact between the gateway devices. As a result, sessions might be routed to a less sustainable gateway device, even when a more sustainable option is available. However, in the present disclosure, the communication management device 202, which has access to the set of sustainability scores, can direct various session activities such as routing sessions, session control, or device registrations from a less sustainable network device to a more sustainable network device.

In an example scenario, the communication management device 202 may receive an incoming collaboration session from the first end-user device 204A. Upon receiving the incoming collaboration session, the communication management device 202 may be configured to identify one or more rules associated with the incoming collaboration session. For example, the communication management device 202 may identify a dialed number (DNIS), a calling number (ANI), a class of service (COS), a session type (e.g., local, international, or toll-free), and/or caller profile, associated with the incoming collaboration session. The communication management device 202 may then use the identified rules to determine a potential set of gateway devices, for example, a route list, that satisfies the identified rules. In the embodiment shown in FIG. 2, the potential set of gateway devices may include the first network device 206A, the second network device 206B, the third network device 206C, the fourth network device 206D, the fifth network device 206E, the sixth network device 206F, and the seventh network device 206G. The route list may be composed of various route groups, for example, a first route group 212A and a second route group 212B, each of which includes a collection of gateway devices capable of routing the incoming collaboration session. The first route group 212A may include the first network device 206A, the second network device 206B, the third network device 206C, and the fourth network device 206D. Further, the second route group 212B may include the fifth network device 206E, the sixth network device 206F, and the seventh network device 206G. A route group may refer to a set of homogeneous network devices that can all route the same collaboration session similarly.

In several embodiments, sequence and priority of route groups may be determined by several factors, for example, geographical proximity to the caller, preferred service provider, time of day routing rules, or the like. In the current example, the communication management device 202 may determine that the first route group 212A has a higher priority than the second route group 212B. In such a scenario, the communication management device 202 may be configured to select a target network device from the first route group 212A based on the sustainability scores of members of the first route group 212A. Since the sustainability score “S1” is highest, the communication management device 202 may select the first network device 206A as the target network device for direct the collaboration session activity. Upon selection of the first network device 206A, the communication management device 202 may route the incoming collaboration session to the first network device 206A. In other words, instead of directing collaboration session activities equally across the plurality of network devices 206A-206G or following a fixed preference, the communication management device 202 determines the sustainability impact of each network device in real time and accordingly directs the collaboration session activities.

In several additional embodiment, the communication management device 202 may be further configured to determine whether the incoming collaboration session routed to the selected first network device 206A is connected successfully. In a scenario where the communication management device 202 determines that the incoming collaboration session has failed, the communication management device 202 may select a new target device from the first route group 212A based on their sustainability scores and re-route the incoming collaboration session to the new target network device. The communication management device 202 may continue down the list, selecting the next gateway device based on its sustainability score until the collaboration session is successfully connected. In a scenario where all options in the first route group 212A are exhausted and the collaboration session is still not connected, the communication management device 202 may select new target network devices from the second route group 212B until the collaboration session is successfully connected or all options are exhausted.

In many further embodiments, the communication management device 202 may be configured to receive one or more updated attributes of the selected target network device at termination of the incoming collaboration session. In many other embodiments, the communication management device 202 may be configured to receive one or more updated attributes of the selected target network device while initiating the incoming collaboration session. In still other embodiments, the communication management device 202 may be configured to receive one or more updated attributes of the selected target network device in a session message during the ongoing collaboration session. The communication management device 202 may determine a new sustainability score for the target network device based on the one or more updated attributes. Based on the new sustainability score, the communication management device 202 may re-sort the plurality network devices 206A-206G.

In several more embodiments, the communication management device 202 may be configured to receive values for one or more new attributes of one or more of the plurality of network devices 206A-206G. For example, one or more new sustainability attributes may be defined by the communication management device 202 and accordingly values for these new attributes may be received for the one or more network devices. In another example, the communication management device 202 may receive updated values for the one or more attributes 210 of one or more of the plurality of network devices 206A-206G. In such scenarios, the communication management device 202 may update corresponding one or more sustainability scores of the set of sustainability scores and re-sort the plurality of network devices 206A-206G.

Though the above example scenario is described with respect to routing an incoming collaboration session to a more sustainable gateway device, the scope of disclosure is not limited to it. The communication management device 202 can direct any collaboration session activity such as collaboration session control operations or device registrations to more sustainable network devices based on their sustainability scores. In further embodiments, the communication management device 202 may compare the set of sustainability scores with a sustainability threshold range. For example, a gateway device may be declared as sustainable if corresponding sustainability score falls within the sustainability threshold range. While another gateway device may be declared as unsustainable if the corresponding sustainability score falls outside the sustainability threshold range. Furthermore, the communication management device 202 can send a power-down signal to an unsustainable network device, allowing it to shut down when it is no longer needed, further reducing energy consumption.

Although a specific embodiment for a schematic block diagram of an example network 200 suitable for carrying out the various steps, processes, methods, and operations described herein is discussed with respect to FIG. 2, any of a variety of systems and/or processes may be utilized in accordance with embodiments of the disclosure. For example, the communication management device 202 may receive values of the one or more attributes 210 during any one of: after termination of a collaboration session, before initiating the collaboration session, during the ongoing collaboration session, or regularly at periodic time intervals. The elements depicted in FIG. 2 may also be interchangeable with other elements of FIGS. 1 and 3-18 as required to realize a particularly desired embodiment.

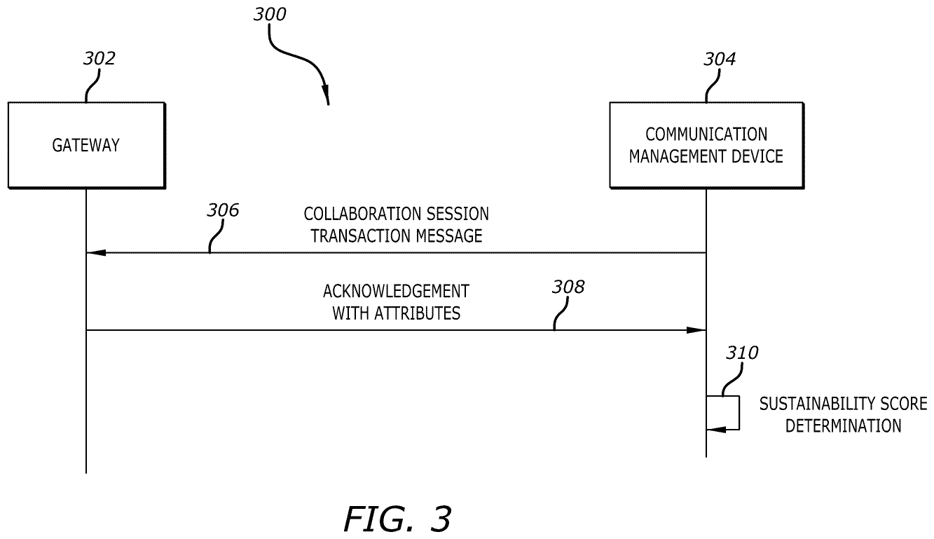

Referring to FIG. 3, a schematic flow diagram 300 that illustrates provision of one or more attributes of a gateway 302 to a communication management device 304 for facilitating sustainability-aware collaboration session activity routing in accordance with various embodiments of the disclosure is shown. Embodiments shown in FIG. 3 may illustrate a scenario where values of the one or more attributes of the gateway 302 are provided to the communication management device 304 in a solicited manner.

In one or more embodiments, the communication management device 304 (for example, a session controller, a collaboration device, a media transaction server, a media termination server, a software conference bridge, a media call processing server, or device registration server, a call controller, or the like) can facilitate dynamic collaboration session activity routing with sustainability awareness. In many embodiments, the communication management device 304 may be configured to receive one or more attributes of the gateway 302 upon session transaction at the gateway 302. For example, the communication management device 304 may request the one or more attributes from the gateway 302 by transmitting a collaboration session message 306. In an example, where the collaboration session corresponds to an ongoing session, the collaboration session message 306 may correspond to a collaboration session transaction message for initiating a communication between, acknowledging the communication, or terminating the communication. The collaboration session message 306 may inform the gateway 302 that the session is being initiated/acknowledged/terminated and the network resources utilized during the session are to be utilized/released. For example, in protocols like SIP, the collaboration session message 306 may include a session termination message that may include, for example “SIP BYE”, or “SIP CANCEL” message. In an example, the communication management device 304 may transmit an SIP BYE message to the gateway 302 to terminate the ongoing session. In yet another example, the collaboration session message 306 may include a session initiation message that may include, for example “INVITE” message that may be utilized to initiate a request to start a real-time communication session, such as a voice or video call, a file sharing session, a media session, etc., typically using protocols like SIP.

In a variety of embodiments, the gateway 302 may be configured to respond to the collaboration session message 306 by sending an acknowledgement “ACK” message 308 to the communication management device 304. For example, upon receiving the SIP BYE message, the gateway 302 may send the ACK message 308 to acknowledge the end of session. In SIP protocol, an example of the ACK message 308 may include “200 OK” message. In additional embodiments, the gateway 302 may be a sustainability-aware device. In such embodiments, the gateway 302 may be configured to send values of one or more attributes along with the ACK message 308. The one or more attributes may include a set of sustainability attributes or a combination of the set of sustainability attributes and a set of non-sustainability attributes. The set of non-sustainability attributes may include, for example, energy consumption, CPU load, network latency, bandwidth utilization, and/or other performance related attributes. Additionally, the set of non-sustainability attributes may include, for example, availability, device temperature, collaboration session handling capacity, or any other attributes that can provide a broader view of the operational impact of the gateway 302. The set of sustainability attributes of the gateway 302 may include those factors that have an environmental impact. Example of sustainability attributes may include but are not limited operational status, utilization rate, energy consumption, energy source, grid reliability, carbon footprint, regional carbon intensity, and power usage effectiveness of the gateway 302. In further embodiments, the ACK message 308 may include an extension field that includes the values of the one or more attributes. For example, the extension field may be associated with a label “sustainability” to indicate the set of sustainability attributes.

In a variety of embodiments, the communication management device 304 may be configured to determine a sustainability score (indicated by arrow 310 in FIG. 3) for the gateway 302 based on the values of the one or more attributes received in the “ACK” message 308. The sustainability score may also be referred to as “the green score” and may include a score derived based on assessing both the set of sustainability attributes and the set of non-sustainability attributes or just the set of sustainability attributes.

In several embodiments, the sustainability score may be further determined based on a sustainability policy that assigns specific weights to the one or more attributes. In other words, the sustainability policy may quantify an impact of an attribute, such as energy consumption, carbon footprint, or geographic carbon intensity, on sustainability. Higher the impact, higher is the weight. In an example scenario, the sustainability policy can be set based on historical operational data of a plurality of gateways and their environment impact. For example, by analyzing past operational data from various gateways under diverse operating conditions, trends can be identified, revealing how each attribute impacts sustainability. Once the attributes are identified, statistical methods, such as regression analysis or machine learning models, can be utilized to evaluate their significance. These methods help quantify the relationship between each attribute and the overall sustainability impact, allowing for the assignment of weights based on their contributions. For example, attributes that show a stronger correlation with sustainability can be assigned higher weights, reflecting their greater influence on sustainability. Finally, sensitivity analysis can be conducted to assess how changes in attribute values affect the impact on sustainability, ensuring that the assigned weights are robust and applicable to various conditions.

Although a specific embodiment for provision of one or more attributes of a gateway to a communication management device for facilitating sustainability-aware collaboration session activity routing suitable for carrying out the various steps, processes, methods, and operations described herein is discussed with respect to FIG. 3, any of a variety of systems and/or processes may be utilized in accordance with embodiments of the disclosure. For example, one or more attributes of the gateway 302 may be received only when the communication management device 304 sends a collaboration session message 306. In numerous embodiments, the one or more attributes of the gateway device 302 may be received by the communication management device 304 at regular time intervals based on keep-alive pings between the gateway 302 and the communication management device 304. The elements depicted in FIG. 3 may also be interchangeable with other elements of FIGS. 1, 2, and 4-18 as required to realize a particularly desired embodiment.

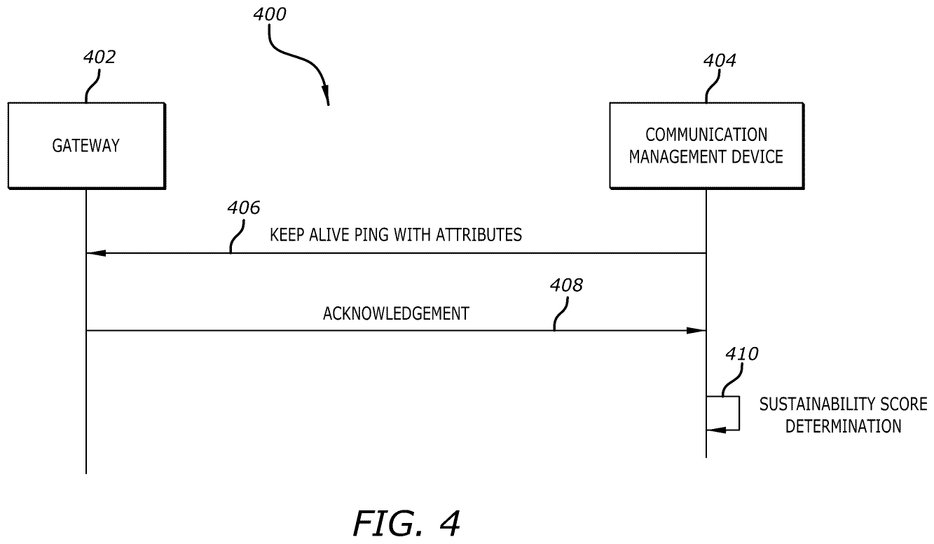

Referring to FIG. 4, a schematic flow diagram 400 that illustrates provision of one or more attributes of a gateway 402 to a communication management device 404 for facilitating sustainability-aware collaboration session activity routing in accordance with various embodiments of the disclosure is shown. Embodiments shown in FIG. 4 may illustrate a scenario where the one or more attributes of the gateway 402 are provided to the communication management device 404 in an unsolicited manner.

In many embodiments, the gateway 402 and the communication management device 404 may often maintain constant connectivity through a process known as “keep-alive pings. “Keep alive pings” may refer to signals sent at regular intervals or upon some trigger from the gateway 402 to the communication management device 404, indicating that the gateway 402 is active and functioning properly. If the communication management device 404 does not receive a keep alive ping within a specified timeframe, the communication management device 404 may assume the gateway 402 may be unresponsive or down, prompting the communication management device 404 to re-route sessions to other gateways.

In a variety of embodiments, the keep-alive pings may allow the communication management device 404 to monitor the health and status of the gateway 402 in real-time without needing constant, high-traffic data exchanges. Examples of protocols used for keep-alive pings may include, for example, SIP OPTIONS, REGISTER, or INVITE messages, PINGs, or ICMP messages. In the example embodiment shown in FIG. 4, the gateway 402 may transmit a keep alive ping 406 to the communication management device 404.

In additional embodiments, the gateway 402 may be a sustainability-aware device. In such embodiments, the gateway 402 may transmit values of one or more attributes of the gateway 402 along with the keep alive ping 406. The one or more attributes of the gateway 402 may correspond to parameters associated with various key performance indices (KPIs) of the gateway 402, for example, energy consumption, CPU load, network latency, carbon emissions, availability, device temperature, session handling capacity, or the like. These KPIs may provide a broader view of the operational and environmental impact of the gateway 402. That is to say, the one or more attributes may include a set of sustainability attributes or a combination of the set of sustainability attributes and a set of non-sustainability attributes.

In a number of embodiments, the communication management device 404 may be configured to receive the values of the one or more attributes from the gateway 402 along with the keep alive ping 406. In further embodiments, the keep alive ping 406 may include an extension field that includes the values of the one or more attributes. For example, the extension field may be associated with a label “sustainability” to indicate the set of sustainability attributes. In additional embodiments, the communication management device 404 may be configured to extract the values of the one or more attributes from the keep alive ping 406 and in response send an acknowledgement 408 to the gateway 402. In a variety of embodiments, the communication management device 404 may be configured to determine a sustainability score for the gateway 402 (indicated by arrow 410 in FIG. 4) based on the values of the one or more attributes extracted from the keep alive ping 406.

Although a specific embodiment for provision of one or more attributes of a gateway to a communication management device for facilitating sustainability-aware collaboration session activity routing suitable for carrying out the various steps, processes, methods, and operations described herein is discussed with respect to FIG. 4, any of a variety of systems and/or processes may be utilized in accordance with embodiments of the disclosure. For example, the attributes of the gateway 402 may not be received by the communication management device 404 directly from the gateway device 402. In numerous embodiments, the attributes may be first collected by a sustainability controller and then sent to the communication management device 404 by the sustainability controller. The elements depicted in FIG. 4 may also be interchangeable with other elements of FIGS. 1-3 and 5-18 as required to realize a particularly desired embodiment.

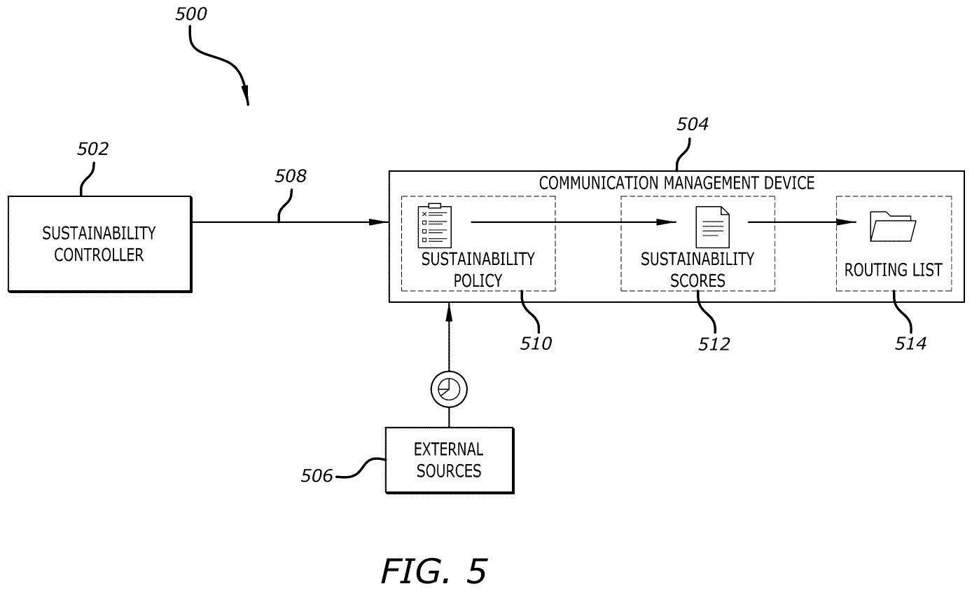

Referring to FIG. 5, a schematic block diagram 500 that illustrates provision of one or more attributes of a network device by a sustainability controller 502 to a communication management device 504 for facilitating sustainability-aware collaboration session activity routing in accordance with various embodiments of the disclosure is shown. Embodiments shown in FIG. 5 may illustrate a scenario where an external sustainability controller 502 may be configured to monitor various network devices as they operate and record their values for the one or more attributes. The one or more attributes may correspond to various factors that influence sustainability. Examples of the one or more attributes may include an operational status, a utilization status, an energy consumed status, an energy source status, a grid risk status, a carbon footprint status, a geographic carbon intensity status, water usage effectiveness, carbon usage effectiveness, or a power usage effectiveness status of a network device. In such embodiments, the network devices may not have inherent capability to record the values of the one or more attributes as they operate and may require an external device to actively monitor and record these values.

In one or more embodiments, the sustainability controller 502 may be communicatively coupled to a plurality of network devices, such as gateways, switches, routers, registration servers, media servers, or the like. Further, in numerous embodiments, the communication management device 504 may be communicatively coupled to the sustainability controller 502 and one or more external data sources 506. For example, in a scenario where the communication management device 504 requires information regarding a geographic location of a network device, the communication management device 504 may query the one or more external data sources 506. Example of the required information may include weather status, climate status, temperature range, carbon footprint associated with the geographic location, or the like. The one or more external data sources 506 may include third-party data aggregators, open-source data collectors, or the like. The communication management device 504 may include suitable logic, circuitry, interfaces, and/or code, executable by the circuitry, that may be configured to perform one or more operations for routing collaboration session activities to more sustainable network devices.

In many embodiments, the sustainability controller 502 may periodically monitor the plurality of network devices to record the values of the one or more attributes. Alternatively, the sustainability controller 502 may monitor the plurality of network devices as a response to a request for transmission of the one or more attributes by the communication management device 504. The one or more attributes may include a set of sustainability attributes or a combination of the set of sustainability attributes and a set of non-sustainability attributes associated with KPIs of the plurality of network devices. The sustainability controller 502 may include suitable logic, circuitry, interfaces, and/or code, executable by the circuitry, that may be configured to perform one or more operations associated with obtaining the values of the one or more attributes for the plurality of network devices. For example, the sustainability controller 502 may be equipped with or include any suitable component, device, ASIC, processor, microprocessor, algorithm, ROM element, RAM element, EPROM, EEPROM, FPGA, or any other suitable element or object that is operable to facilitate the operations thereof.

In still more embodiments, the sustainability controller 502 may be further configured to transmit a notification message 508, including the values of the one or more attributes, to the communication management device 504. In numerous additional embodiments, the communication management device 504 may include a sustainability policy 510 that defines specific weights assigned to each of the one or more attributes. That is to say, the sustainability policy 510 may outline how much importance or influence each attribute has on sustainability by assigning the specific weight to each attribute. For example, attributes such as energy consumption, carbon emissions, and CPU load may each be assigned different weights based on their importance to sustainability. Energy consumption might be given a higher weight, as it has a direct impact on reducing the carbon footprint, while CPU load might have a lower weight since it indirectly affects power efficiency. For example, in the sustainability policy 510, energy consumption could be weighted at 50%, carbon emissions at 30%, and CPU load at 20%. Thus, the sustainability policy 510 may define how much weight each attribute carries in determining a sustainability score of a network device. Based on the sustainability policy 510, the values of the one or more attributes received from the sustainability controller 502, and data received from the one or more external data sources 506, the communication management device 504 may determine comprehensive sustainability scores 512 for the plurality of network devices.

In various embodiments, the communication management device 504 may be configured to maintain a routing list 514 of all network devices that are available for routing collaboration session activities. The sustainability scores 512 may enable the communication management device 504 to sort the plurality of network devices on the basis of their impact on sustainability and environment in the routing list 514. For example, the plurality of network devices in the routing list 514 may be sorted in a descending order based on their sustainability scores 512. In another example, the plurality of network devices in the routing list 514 may be sorted in an ascending order based on their sustainability scores 512.

In several embodiments, the routing list 514 may further include one or more network devices whose sustainability scores may not be determined due to insufficient data. In many examples, the communication management device 504 may assign lowest priorities to such network devices for collaboration session activity routing. The communication management device 504 may be configured to utilize the routing list 514 for directing collaboration session activities to suitable network devices in a sustainability-aware manner. For example, the communication management device 504 may select a target network device from the plurality of network devices in the routing list 514 based on the sustainability scores 512. In other words, the communication management device 504 may choose the target network device that aligns best with sustainability goals, such as reducing energy use or minimizing carbon emissions. Any collaboration session established by an end user may be routed to the target network device with the most optimal sustainability score.

In many further embodiments, the communication management device 504 may receive values for one or more new attributes of one or more network devices of the plurality of network devices. In such a scenario, the communication management device 504 may update sustainability scores 512 of the one or more network devices and update the sorting of the routing list 514 as per the updated sustainability scores 512.

Although a specific embodiment for provision of one or more attributes of a network device by an external sustainability controller to a communication management device for facilitating sustainability-aware collaboration session activity routing suitable for carrying out the various steps, processes, methods, and operations described herein is discussed with respect to FIG. 5, any of a variety of systems and/or processes may be utilized in accordance with embodiments of the disclosure. For example, the communication management device 504 may be configured to utilize one or more machine learning models for determining the sustainability scores 512. The plurality of collaboration session activities can include device registration activities. The elements depicted in FIG. 5 may also be interchangeable with other elements of FIGS. 1-4 and 6-18 as required to realize a particularly desired embodiment.

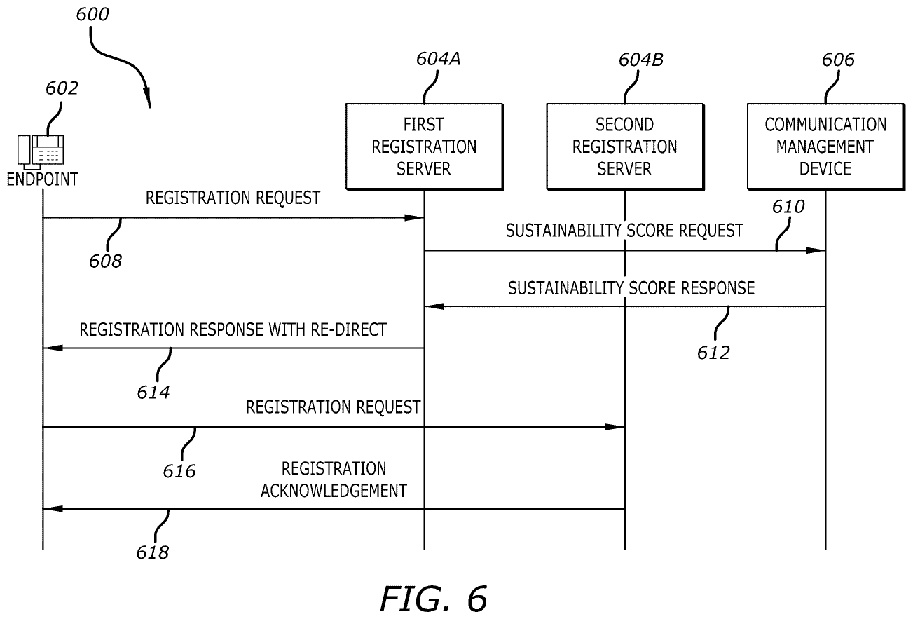

Referring to FIG. 6, a schematic flow diagram 600 that illustrates a sustainability-aware device registration process in accordance with various embodiments of the disclosure is shown. The embodiments shown in FIG. 6 illustrate an end-user device 602 that is to be registered with one of a first registration server 604A or a second registration server 604B in a sustainability aware manner. The embodiments shown in FIG. 6 further illustrate a communication management device 606 coupled to the first and second registration servers 604A and 604B and may be configured to enable the sustainability-aware device registration process. For example, the communication management device 606 may be configured to select a target registration server between the first registration server 604A and the second registration server 604B and direct a registration request to the target registration server.

In an example scenario, the end-user device 602 may be required to register with a registration server to participate in various collaboration session activities. Thus, the end-user device 602 may transmit a registration request 608 to the first registration server 604A. In an example, the registration request 608 is an “SIP REGISTER” request.

On receiving the registration request 608, the first registration server 604A may transmit a sustainability score request 610 to the communication management device 606. In a variety of embodiments, the sustainability score request 610 may be configured to indicate an identifier of the first registration server 604A. Upon receiving the sustainability score request 610, the communication management device 606 may determine whether the first registration server 604A is scored best among various registration servers in terms of sustainability score. For example, the communication management device 606 may be configured to maintain a score database that includes sustainability scores of various registration servers. Upon receiving the sustainability score request 610, the communication management device 606 may look-up the score database using the identifier of the first registration server 604A and obtain a first sustainability score of the first registration server 604A. The communication management device 606 may then compare the first sustainability score with sustainability scores of other registration servers. In a scenario where the communication management device 606 determines that another registration server has a better sustainability score than the first registration server 604A, the communication management device 606 may obtain an identifier of the other registration server. For example, in the current example scenario, on comparison, the communication management device 606 may determine that the first sustainability score is less optimal than a second sustainability score of the second registration server 604B. As a result, the communication management device 606 may select the second registration server 604B as a target network device for the device registration of the end-user device 602. In still additional embodiments, the communication management device 606 may transmit a sustainability score response 612 to the first registration server 604A directing the device registration request of the end-user device 602 to the second registration server 604B. In an example, the sustainability score response 612 may include a message for the first registration server 604A “Use second registration server 604B having more optimal sustainability score” to direct the device registration of the end-user device 602 to the second registration server 604B.

In still more embodiments, based on the sustainability score response 612 directing the device registration of the end-user device 602 to the second registration server 604B, the first registration server 604A may transmit a registration response with re-direct message 614 to the end-user device 602. The re-direct message 614 may include contact information, for example, an identifier or a weblink, of the second registration server 604B. In an example, the registration response with re-direct message 614 may be a “302 Moved Temporarily” message with a weblink link of the second registration server 604B.

Upon receiving the registration response with re-direct message 614, the end-user device 602 may transmit a new registration request 616 to the second registration server 604B. The second registration server 604B may respond with a registration acknowledgement message 618 (e.g., SIP 200 OK) to indicate successful registration. In numerous embodiments, prior to transmitting the registration acknowledgement message 618 to the c, the second registration server 604B may also transmit a sustainability score request to the communication management device 606. In a scenario where the communication management device 606 approves the device registration, the second registration server 604B may transmit the registration acknowledgement message 618 to the end-user device 602. Thus, the end-user device 602 may be successfully registered with the optimal second registration server 604B that balances both performance and sustainability. All further SIP communications (e.g., INVITE messages for sessions) of the end-user device 602 may be routed through the second registration server 604B until the sessions may be dropped or terminated.

Although a specific embodiment for a sustainability-aware device registration process suitable for carrying out the various steps, processes, methods, and operations described herein is discussed with respect to FIG. 6, any of a variety of systems and/or processes may be utilized in accordance with embodiments of the disclosure. For example, the communication management device 606 may be configured to dynamically transfer an active device registration or an active collaboration session activity to another server that better aligns with sustainability goals, such as lower energy consumption or reduced carbon emissions. The elements depicted in FIG. 6 may also be interchangeable with other elements of FIGS. 1-5 and 7-18 as required to realize a particularly desired embodiment.

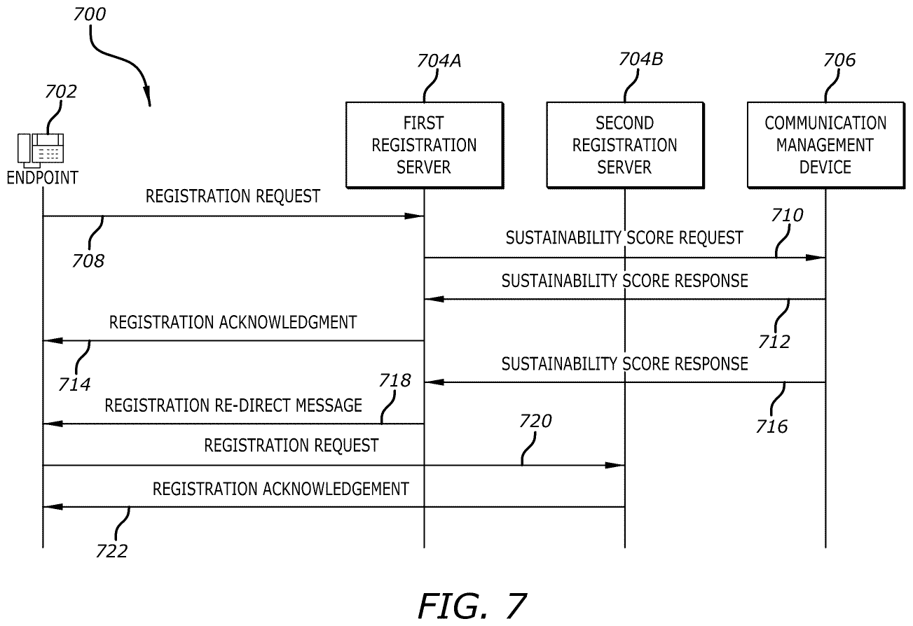

Referring to FIG. 7, a schematic flow diagram 700 that illustrates a sustainability-aware dynamic device registration process in accordance with various embodiments of the disclosure is shown. Device registration is a process where a network device, such as a phone or an end-user device 702, may register with one or more registration servers (e.g., an SIP server) to participate in one or more collaboration session activities. During this process, the end-user device 702 may provide information (for example, IP address, capabilities, current status, etc.) for collaboration session routing purposes. In collaboration session routing, registration ensures that only authenticated, available, and eligible devices are included in collaboration session-handling process for communication tasks.

Thus, in many embodiments, the end-user device 702 may transmit a registration request 708 (e.g., a SIP REGISTER message) to a first registration server 704A operatively coupled to a communication management device 706. In a variety of embodiments, the registration request 708 may include one or more credentials and other relevant information (e.g., IP address, device attributes) associated with the end-user device 702.

On receiving the registration request 708, the first registration server 704A may transmit a sustainability score request 710 to the communication management device 706. In a variety of embodiments, the sustainability score request 710 may be configured to indicate an identifier of the first registration server 704A. Upon receiving the sustainability score request 710, the communication management device 706 may determine whether the first registration server 704A is scored best among various registration servers in terms of sustainability score. For example, the communication management device 706 may be configured to look-up a score database using the identifier of the first registration server 704A and obtain a sustainability score of the first registration server 704A. The communication management device 706 may then compare the sustainability score with sustainability scores of other registration servers. In a scenario where the communication management device 706 determines that the first registration server 704A has the best sustainability score, the communication management device 706 may transmit a sustainability score response 712 to the first registration server 704A indicating that the device registration process may continue via the first registration server 704A. Thus, the first registration server 704A may transmit a registration acknowledgement message 714 to the end-user device 702.

In yet more embodiments, the communication management device 706 may be configured to continuously monitor the KPIs and sustainability attributes of all registration servers, for example, the first registration server 704A and a second registration server 704B, through collaboration session messages or keep alive pings. Thus ensuring, if any conditions change, for example, a previously idle registration server becomes overloaded or a more energy-efficient registration server becomes available, future registration requests can be re-directed accordingly, ensuring continuous alignment with sustainability goals.

Thus, in an example scenario where the communication management device 706 determines that the sustainability score of the first registration server 704A has dropped or the second registration server 704B is now scored best in terms of sustainability goals as compared to other registration servers, the communication management device 706 may transmit a new sustainability score response 716 to the first registration server 704A indicating that the sustainability score of the second registration server 704B is better than the first registration server 704A, and therefore, the device registration of the end-user device 702 has to be redirected to the second registration server 704B. In an example, the new sustainability score response 716 may include a message for the first registration server 704A “Use second registration server 704B having more optimal sustainability score” to re-direct the device registration of the end-user device 702 to the second registration server 704B.

In still more embodiments, based on the new sustainability score response 716, the first registration server 704A may transmit a registration response with re-direct message 718 to the end-user device 702. The registration response with re-direct message 718 may notify the end-user device 702 to redirect the device registration to the second registration server 704B. In other words, the first registration server 704A may notify the end-user device 702 to re-register with the second registration server 704B. In one or more embodiments, the registration response with re-direct message 718 may further indicate a reason for requiring re-registration. For example, the registration response with re-direct message 718 may include a tag, a label, or metadata indicating “sustainability-based redirect”.

Upon receipt of the registration response with re-direct message 718, the end-user device 702 may transmit a registration request 720 to the second registration server 704B. The second registration server 704B may respond with a registration acknowledgement message 722 to indicate successful registration. The end-user device 702 may be now successfully registered with the second registration server 704B. All further SIP communications (e.g., INVITE messages for sessions) may be routed through this more sustainable second registration server 704B until another more sustainable registration server becomes available.

Thus, in a non-limiting example, based on sustainability-aware device registration, devices may be prompted to move an active registration and re-register with more sustainable registration servers dynamically. In many additional embodiments, the communication management device 706 may enable powering down of underutilized less sustainable servers that may no longer be needed. Furthermore, device registrations can be directed by the communication management device 706 to registration servers in regions with lower carbon emissions, such as areas relying more on renewable energy sources like wind or solar. By doing this, the overall environmental impact of the network operations can be reduced. For instance, a collaboration session that would typically be routed through a server in a high-carbon region might instead be handled by a server in a region with a cleaner energy grid, such as moving a collaboration session from a coal-dependent region to a renewable energy-powered server.

In various embodiments, similar to the foregoing description of controlling device registration affinity and dynamic device re-registration based on sustainability scores, other media or collaboration session activities can also be dynamically controlled based on techniques such as session transfers, mid-session media renegotiation (e.g. RE-INVITE). Example of other collaboration session activities may include optimizing or moving media termination to other network devices or altering the codecs.

Although a specific embodiment for a sustainability-aware dynamic device registration process suitable for carrying out the various steps, processes, methods, and operations described herein is discussed with respect to FIG. 7, any of a variety of systems and/or processes may be utilized in accordance with embodiments of the disclosure. For example, though the communication management device 706 is shown to be a separate entity, the scope of the disclosure is not limited to it. In several additional embodiments, the communication management device 706 may be embodied locally within the registration servers. In such a scenario, each registration server may be configured to share its sustainability scores with other registration servers as well as maintain a record of sustainability scores of the other registration servers. Thus, when such a registration server receives a registration request, the registration server may verify whether any other registration server has a better sustainability score and accordingly decide whether to approve or re-direct the device registration request. The elements depicted in FIG. 7 may also be interchangeable with other elements of FIGS. 1-6 and 8-18 as required to realize a particularly desired embodiment.

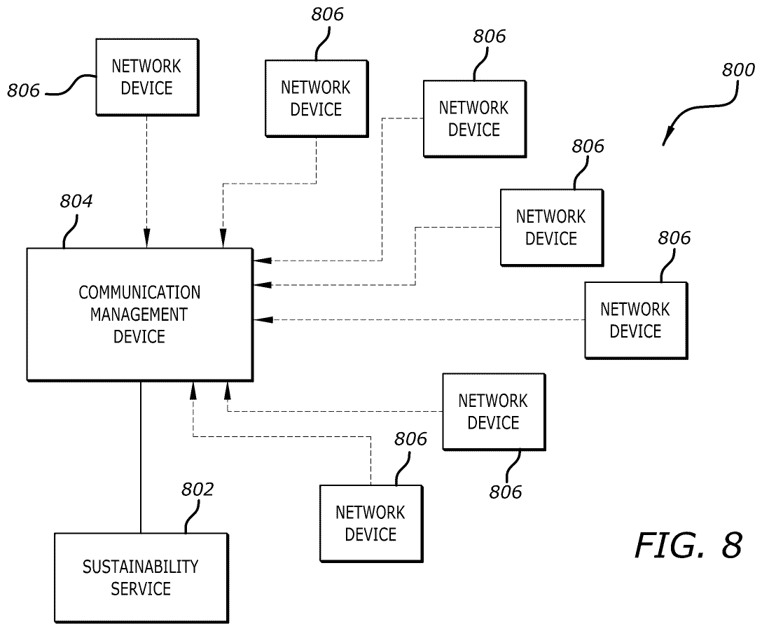

Referring to FIG. 8, a conceptual illustration of an example sustainability-aware collaboration session activity routing system 800 in accordance with various embodiments of the disclosure is shown. As shown in the embodiment depicted in FIG. 8, the sustainability-aware collaboration session activity routing system 800 can include a sustainability service 802, a communication management device 804, and a plurality of network devices 806. The plurality of network devices 806 can encompass various network devices utilized within a communication network. Examples of the plurality of network devices 806 may include, but are not limited to, gateways, servers, switches, firewalls, routers, etc. Although only seven network devices 806 are shown in the embodiment depicted in FIG. 8, this is just an example, and is not meant to be limiting. As such, the sustainability-aware collaboration session activity routing system 800 can include any number of network devices 806 as needed to realize the desired application.

In various embodiments, the sustainability service 802 may be a component or system within a network infrastructure responsible for overseeing and optimizing sustainability-related aspects of communication operations. The sustainability service 802 may be configured to monitor, manage, and enhance the environmental impact of various services and devices within the network, such as servers, gateways, end-user devices, or the like. In a non-limiting example, the sustainability service 802 can be configured to monitor and update sustainability aspects of the plurality of network devices 806. In further embodiments, the sustainability service 802 can communicate with the communication management device 804 to enable various operations for sustainability-aware collaboration session activity routing. In one or more embodiments, the sustainability service 802 can be included within the communication management device 804 and/or the plurality of network devices 806 or may be externally embodied as a sustainability controller.

As shown, the communication management device 804 can be configured to communicate with the plurality of network devices 806 to receive data. In many embodiments, this data can include, but is not limited to, sustainability and non-sustainability related data. For example, the communication management device 804 may be configured to receive values of a set of sustainability attributes exhibited by the plurality of network devices 806 during their operations. The communication management device 804 can be configured as a computing device or application to which the plurality of network devices 806 may periodically communicate metrics, scores, and other sustainability related data. In certain embodiments, the communication management device 804 can be implemented as part of a Software Defined Networking (SDN) application or as a part of any resource manager or ecosystem management tool framework itself to communicate and retrieve infrastructure data. In one or more embodiments, the communication management device 804 can monitor and collect the sustainability and non-sustainability related data from the plurality of network devices 806 and store the collected data in tables.

In various embodiments, the communication management device 804 can provide the received sustainability and non-sustainability data to the sustainability service 802 to enable determination of sustainability scores of the plurality of network devices 806. The sustainability service 802 may receive the sustainability and non-sustainability data from the communication management device 804 and determine the sustainability scores of the plurality of network devices 806. In more embodiments, the sustainability service 802 may utilize one or more statistical aggregation techniques, such as weighted sum, weighted average, or the like, on the sustainability and non-sustainability data to determine the sustainability scores of the plurality of network devices 806. In yet more embodiments, the sustainability service 802 may utilize a trained machine learning model to determine the sustainability scores of the plurality of network devices 806.

In some more embodiments, the sustainability service 802 may provide the sustainability scores to the communication management device 804. The communication management device 804 can utilize the sustainability scores to perform sustainability-aware collaboration session activity routing. For example, routing a collaboration session activity to a more sustainable network device in comparison to a less sustainable network device. In many additional embodiments, the sustainability service 802 can be configured to update the sustainability scores of the plurality of network devices 806 based on changes in the sustainability data of the plurality of network devices 806.

Although specific embodiments for a sustainability-aware collaboration session activity routing system 800 suitable for carrying out the various steps, processes, methods, and operations described herein is discussed with respect to FIG. 8, any of a variety of systems and/or processes may be utilized in accordance with embodiments of the disclosure. For example, the sustainability service 802 may be a cloud-based service accessed by the communication management device 804 for executing sustainability-aware collaboration session activity routing. The elements depicted in FIG. 8 may also be interchangeable with other elements of FIGS. 1-7 and 9-18 as required to realize a particularly desired embodiment. More details about sustainability aware collaboration session routing are described below.

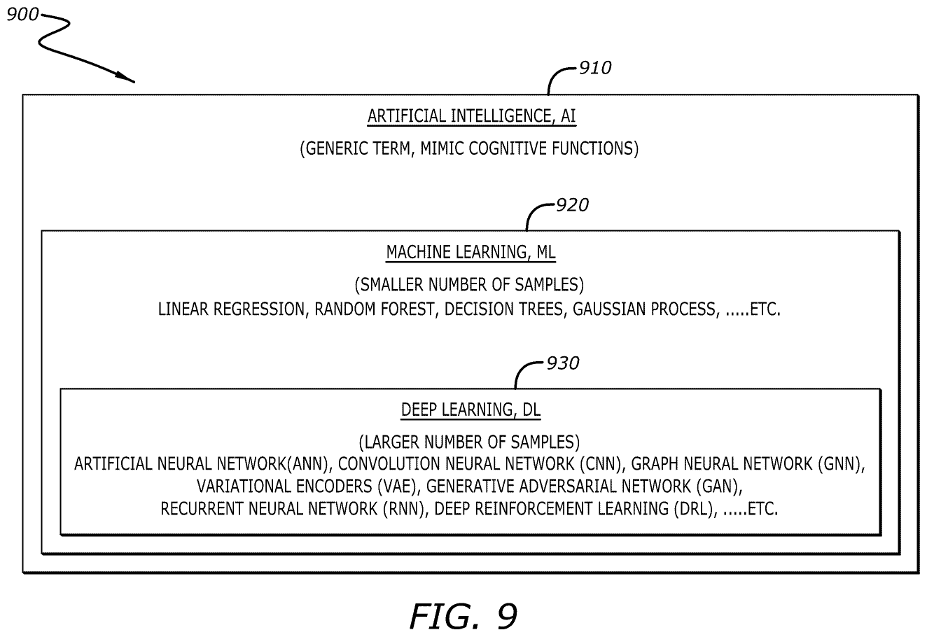

Referring to FIG. 9, a diagram 900 depicting various subsets of artificial intelligence in accordance with various embodiments of the disclosure is shown. Artificial intelligence (AI) 910 is typically understood in the art to be the development of machines and algorithms that mimic human intelligence, for example, by optimizing actions to achieve certain goals. At its core, AI 910 often involves designing algorithms and models that mimic cognitive functions, such as learning, reasoning, problem-solving, perception, and even language understanding. Unlike traditional computer programs that follow a fixed set of instructions, AI systems have the ability to adapt, improve, and make decisions based on input data and environmental interactions.

AI 910 can be considered a generic term because it encompasses a wide range of subfields and techniques, from simple rule-based systems to advanced machine learning and deep learning models. These AI techniques are used to simulate various aspects of human cognition. For example, machine learning (ML) 920 allows computers to learn from data patterns without explicit programming for each task, while natural language processing (NLP) enables machines to understand and generate human language. Deep learning (DL) 930, a more advanced branch of AI, uses neural networks to automatically learn complex patterns from large datasets, akin to the human brain's information processing. This versatility makes AI a powerful tool across diverse applications, including image recognition, autonomous driving, voice assistants, healthcare diagnostics, and materials discovery.

A goal of AI is often to create systems that can function autonomously and intelligently in real-world scenarios. As AI 910 continues to evolve, it can increasingly mirror human-like cognition, enabling machines to not just process data but to “think” in a way that can handle uncertainty, make predictions, and even interact with their surroundings in a meaningful manner. While AI systems are far from achieving the full breadth of human intelligence, their ability to replicate specific cognitive functions makes them invaluable in tackling complex, data-driven challenges.

Machine Learning (ML) 920 is a subset of Artificial Intelligence (AI) 910 that focuses on the development of algorithms and statistical models that enable computers to learn and make decisions from data without explicit programming. In traditional programming, a computer is given a fixed set of rules to follow, but ML 920 can shift this paradigm by allowing systems to identify patterns, adapt, and improve their performance based on the data they encounter. This data-driven approach makes ML particularly valuable for tasks that are too complex or dynamic to define using straightforward rules, such as, for example, recognizing images, predicting consumer behavior, or diagnosing diseases. In various embodiments described herein, machine-learning methods may be utilized to execute sustainability-aware collaboration session activity routing.

ML models can be configured to analyze large amounts of data to identify trends and relationships that inform their predictions or classifications. The process typically involves three stages: training, validation, and testing. During training, the model learns from a dataset by adjusting its internal parameters to minimize errors between its predictions and the actual results. Techniques like linear regression, decision trees, random forests, and Gaussian processes are commonly used in ML 920. These algorithms can handle various data types, including numerical, categorical, and structured datasets like spreadsheets or grids. One of the key strengths of ML is its ability to generalize from the training data to make accurate predictions on new, unseen data. In a number of embodiments described herein, training data may be generated from historical attribute data and sustainability scores of known network devices.

However, traditional ML methods rely heavily on feature engineering, wherein human experts manually identify the most relevant features or patterns within the data. For example, when using ML 920 for image recognition, an expert might need to extract features like edges, textures, or color patterns before feeding them into a model. This requirement can limit the scalability of traditional ML approaches, especially when dealing with large, unstructured datasets such as images, text, or graphs. Additionally, ML algorithms may often work best when provided with relatively structured data, and they often need a reasonable number of samples (typically more than 100) to learn effectively.

Deep Learning (DL) 930 is a specialized subset of Machine Learning (ML) 920 that employs multi-layered artificial neural networks to automatically learn complex patterns and representations from large, often unstructured datasets. Inspired by the way the human brain processes information, DL 930 consists of interconnected layers of “neurons” that can adaptively change as they are exposed to more data. Unlike traditional ML methods, which require manual feature engineering to identify key data characteristics, DL models can automatically extract features directly from raw data, such as images, numerical, text, or molecular structures. This automated feature extraction allows DL 930 to handle data types and tasks that were previously difficult or impossible for ML models to tackle effectively.

DL models, including Convolutional Neural Networks (CNNs), Graph Neural Networks (GNNs), and Recurrent Neural Networks (RNNs), excel at processing various forms of data. CNNs are particularly effective for image analysis, recognizing intricate patterns in visual inputs, making them indispensable in areas like materials science for analyzing microscopic images or detecting defects in materials. GNNs, on the other hand, are designed to work with graph-based data, such as molecular structures, social networks, or atomic interactions. They can learn the dependencies and relationships within graph-like structures, which is crucial for predicting properties of complex molecules and materials. RNNs and their variants, such as Long Short-Term Memory (LSTM) networks, are suited for sequential data like time series or natural language processing, allowing for the analysis and generation of textual information or the prediction of temporal patterns in scientific research.

One of the defining characteristics of deep learning is its requirement for large datasets (typically over 500 samples for example) to effectively train neural networks. The deep, multi-layered structure of these networks enables them to capture highly complex and abstract representations of the data, but it also demands significant computational power. Techniques like Variational Autoencoders (VAEs) and Generative Adversarial Networks (GANs) add to the versatility of DL by enabling the generation of new data samples that resemble the training set, aiding in areas such as materials discovery and synthetic data creation. Deep Reinforcement Learning (DRL) combines neural networks with decision-making processes to solve problems that involve optimization and control, further expanding DL's application potential. In summary, DL's ability to automatically learn from raw, unstructured data and model intricate patterns makes it a powerful tool in AI, particularly for complex domains like image recognition, natural language processing, and materials science.

Artificial Neural networks (ANNs or sometimes just NNs) are often a foundation of a DL system. The basic unit of a neural network is typically the perceptron, which can take inputs, assigns weights to these inputs, and combines them to produce an output. The final output is then passed through an activation function (such as, for example, ReLU, sigmoid, or hyperbolic tangent) to introduce non-linearity, which enables the network to model complex patterns.

Neural networks are typically trained through a process of backpropagation, where the system's predictions are compared against the known output, and a loss function is used to measure the difference between the prediction and the actual result. The network's weights can be adjusted through a process called gradient descent, which can be configured to minimize the loss function over time. However, the training process can be prone to problems like overfitting (where the model performs well on the training data but poorly on new data). To counter this, techniques such as regularization (e.g., regularization, dropout), early stopping, and mini-batches can be utilized to prevent the network from becoming overly specialized to the training set.

CNNs are a specific type of ML 930 neural network designed to work particularly well with spatial data, for example image data. However, CNNs can also work with non-image data, for example, values of sustainability attributes, of a network device, structured as a vector of features as input data. As those skilled in the art will recognize, CNNs typically use specialized layers known as convolutional layers, which apply filters (also known as kernels) to the input data. These filters slide over the input data, detecting patterns, which are then passed to the next layer for further processing. The advantage of CNNs is their ability to automatically learn and extract relevant features from raw data without the need for manual feature engineering. Furthermore, pooling layers (e.g., max-pooling or average pooling) are often added after convolutional layers to reduce the dimensionality of the data, helping to make the system more efficient while retaining the most important information. After several layers of convolutions and pooling, the CNN can output a prediction, such as determining a sustainability score for a network device. The determined sustainability score may be utilized to make sustainability-aware collaboration session activity routing decisions within communication networks.

Graph Neural Networks (GNNs) can be utilized to operate on graph-based data. In GNNs, information is passed between nodes through edges in a process called message passing. This allows the network to capture dependencies and relationships within the graph structure. The key feature of GNNs is their ability to aggregate information from neighboring nodes, which is required for predicting properties that depend on the current/local structure, such as sustainability behavior of a network device.

Generative models aim to learn the underlying distribution of a dataset and generate new samples that resemble the original data. Two common types of generative models are Variational Autoencoders (VAEs) and Generative Adversarial Networks (GANs). VAEs are often configured to work by encoding data into a lower-dimensional latent space and then decoding it back into its original form. This allows for the generation of new data by sampling points from the latent space. This can be utilized when attempting to predict values for sustainability attributes for a network device that is incapable of monitoring the sustainability attributes during its operations. As a result, generative models can be utilized to determine sustainability scores for even those network devices for which the values of sustainability attributes have not been received.

Similarly, GANs consist of two components: a generator that creates fake/generated data and a discriminator that tries to distinguish between real and fake data. The two components are trained in a competitive process where the generator tries to “fool” the discriminator, leading to increasingly realistic generated data. This type of process may be utilized to compare predicted and actual values of the sustainability attributes.

Reinforcement Learning (RL) involves an agent learning to make decisions by interacting with an environment and receiving feedback (rewards or penalties) based on its actions. Deep Reinforcement Learning (DRL) combines RL with DL techniques, allowing agents to learn from high-dimensional inputs, such as values of sustainability attributes of various network devices.

In a communication network comprising a plurality of network devices such as gateways, registration servers, switches, routers, etc. DRL can be used in scenarios where an optimal decision needs to be made, such as selecting a target network device for directing a collaboration session activity based on sustainability scores. The combination of RL and DL can allow for learning from raw data, making it a powerful tool for dynamic and real-time decision-making within the communication network.

Although a specific embodiment for a diagram 900 depicting various subsets of artificial intelligence suitable for carrying out the various steps, processes, methods, and operations described herein is discussed with respect to FIG. 9, any of a variety of systems and/or processes may be utilized in accordance with embodiments of the disclosure. For example, other subset may be present and available for use within AI 910. Those skilled in the art will recognize that the diagram 900 presented in FIG. 9 is simplified for illustration purposes and various methods and techniques may interact with other areas (ML 920 with DL 930, etc.). The elements depicted in FIG. 9 may also be interchangeable with other elements of FIGS. 1-8 and 10-18 as required to realize a particularly desired embodiment.

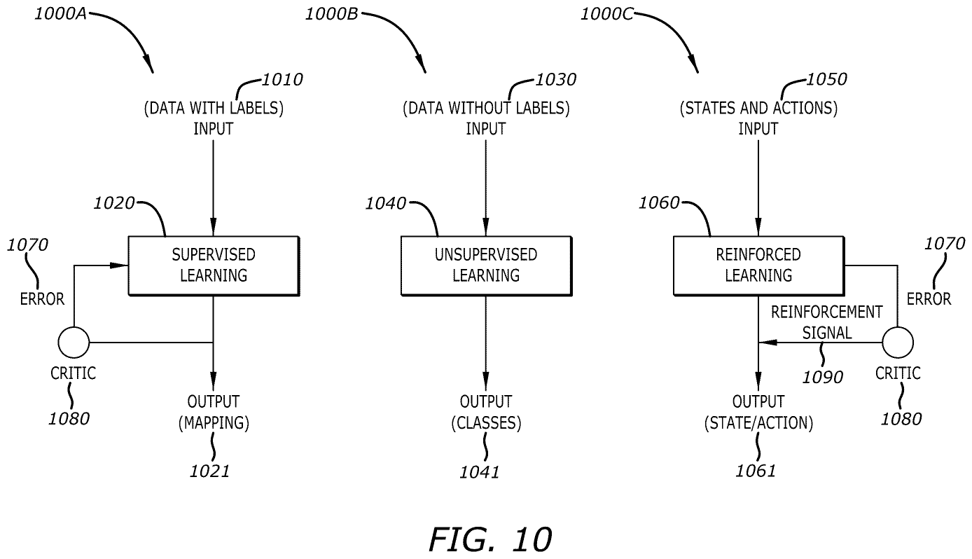

Referring to FIG. 10, different methods of machine-based learning in accordance with various embodiments of the disclosure are shown. In many embodiments, a machine learning model is defined as a mathematical representation of the output of the training process. A machine learning model is often considered similar to computer software designed to recognize patterns or behaviors based on previous experience or data. However, the learning algorithm can discover patterns within the training data, and output an ML model which can capture these patterns and make predictions on new data.

ML models can be understood as a device that has been trained to find patterns within new data and make predictions. These models can be represented as a complex mathematical function that would be impractical for a human to calculate that takes requests in the form of input data, makes predictions on input data, and then provides an output in response. First, these models can be trained over a set of data, and then they are provided an algorithm or other task to reason over data, extract the pattern from feed data and learn from that data. Once the model(s) is/are trained, they can be used to predict a new and previously unseen dataset.

There are various types of machine learning models available based on different business goals and data sets available. Often, based on the desired application, ML models can be configured as or settle into one of three different model types: supervised learning, unsupervised learning, and/or reinforcement learning. Supervised learning can further be broken down into two categories of classification and regression. Likewise, unsupervised learning can be divided into three categories: clustering, association rule, and/or dimensionality reduction.

In the embodiment depicted in FIG. 10, a supervised learning system 1000A is shown. The supervised learning system 1000A can be configured with a supervised learning model 1020 that accepts input data 1010 and generates an output 1021. However, the output data is often reviewed by a critic 1080 that can determine one or more errors 1070 that are fed back into the supervised learning model 1020 for use in updating.

Supervised learning systems 1000A are often considered the simplest machine learning model to understand in which input data (such as training data) has a known label or result as an output. So, the supervised learning model 1020 can be understood to work on the principle of input-output pairs. As such, a function can be trained using a training data set, which is then applied to unknown data and makes some predictive performance. Supervised learning is task-based and mostly tested on labeled data sets.

Supervised learning systems 1000A may often involve one or more regression problems. In regression problems, the output is a continuous variable. Some commonly used Regression models include linear regression, decision trees, and random forests. Linear regression is typically the most straight forward machine learning model in which a prediction of one output variable is made using one or more input variables. The representation of linear regression can be processed as a linear equation, which combines a set of input values (denoted as x) and a predicted output (denoted as y) for the set of those input values. As those skilled in the art will recognize, this may be represented in the form of a line: Y=bx+c. A typical aim of a linear regression-based model can be to find the optimal fit line that best fits the available data points. Linear regression can be extended to multiple linear regressions (finding a plane of best fit in higher dimensional space) and polynomial regressions (finding the best fit curve).

Decision trees are also popular machine learning models that can be used for both regression and classification problems. A decision tree uses a tree-like structure of decisions along with their possible consequences and outcomes. In this, each internal node is used to represent a test on an attribute while each branch is used to represent the outcome of the test. The more nodes a decision tree has, the more accurate the result will be. This may be used when making decisions related to determining sustainability scores of a plurality of network devices and then selecting a target network device from the plurality of network devices for directing a collaboration session activity based on the sustainability scores. The advantage of decision trees is that they are intuitive and easy to implement, but may lack accuracy depending on the available computational or time resources available.

Random forests are an ensemble learning method, which may consist of a large number of decision trees. For example, each decision tree in a random forest predicts an outcome, and the prediction with the majority of votes is considered as the outcome. A random forest model can be used for both regression and classification problems. For the classification task, the outcome of the random forest may be taken from the majority of votes. Whereas in the regression task, the outcome can be taken from the mean or average of the predictions generated by each tree.

Classification models are another type of supervised learning, which can be used to generate conclusions from observed values in one or more categorical forms. For example, a classification model can identify if an email is spam or not; whether a certain network device can be declared unsustainable, etc. Classification algorithms can also be used to predict between two or more classes and/or categorize an output into different groups. For these classification systems, a classifier model can be designed that classifies the dataset into different categories, and each category can subsequently be assigned a label. As those skilled in the art will recognize, there are currently two main types of classifications in machine learning: binary and multi-class. Binary classification can be utilized when there are only two possible classes (i.e., yes/no, dog/cat, etc.). Multi-class classification can be utilized when there are more than two possible classes, thus requiring a multi-class classifier.

One of the potential classification processes is logistic regression. Logistic regression can be used to solve various classification problems in machine learning systems. These processes are similar to linear regression but are often used to predict categorical variables. While some variations can be configured to generate a prediction as an output in either “yes” or “no”, 0 or 1, “true” or “false”, etc. However, in some embodiments, the system can instead be configured to not give exact values, but instead provide probabilistic values between zero and one, etc.

Another classification process that can be utilized is a support vector machine (SVM) which is widely used for classification and regression tasks. However, the main aim of SVM is to find the best decision boundaries in an N-dimensional space, which can be utilized to segregate data points into classes, and generate a best decision boundary often known as a hyperplane. SVM processes can select the extreme vector to find a hyperplane, wherein these vectors are known as support vectors.

Naïve Bayes is another popular classification algorithm used in machine learning. This process receives its name as it is based on Bayes theorem and follows the naïve (independent) assumption between the features which is often given as the formula:

$$P ( y \vert X ) = \frac{P ( X \vert y ) * P ( y )}{P ( X )}$$

This formula takes a class or target y and a predictor attribute (X) and calculates a posterior probability P(y|X) of that class given a particular predictor. P(y) is the prior probability of that class, P(X) is the prior probability of the predictor, and P(X|y) is the likelihood or probability of the predictor given the class. As those skilled in the art will recognize, this may be more succinctly understood as the posterior chance being a result of the prior results times the likelihood divided by the evidence available. Each naïve Bayes classifier assumes that the value of a specific variable is independent of any other variable/feature. For example, if a fruit needs to be classified based on color, shape, and taste. So yellow, oval, and sweet will be recognized as mango. Here each feature is independent of other features. Likewise, various embodiments herein can classify a network device as sustainable or non-sustainable based on values sustainability attributes exhibited by the network device.

Again, in the embodiment depicted in FIG. 10, an unsupervised learning system 1000B is shown. The unsupervised learning system 1000B can be configured with an unsupervised learning model 1040 that accepts input data 1030 and generates an output 1041. Unlike other model types, there are no critics or error signals to process. Unsupervised learning models 1040 can implement the learning process opposite to supervised learning, which means it enables the model to learn from an unlabeled training dataset. Based on the unlabeled dataset, the unsupervised learning model 1040 can predict the output. Using an unsupervised learning system 1000B, the unsupervised learning model 1040 can learn hidden patterns from the dataset by itself without any supervision. In various embodiments, unsupervised learning models 1040 are often utilized to perform tasks involving clustering, association rule learning, and/or dimensional reduction.

Clustering is an unsupervised learning technique that involves clustering or grouping the available data points into different clusters based on similarities and/or differences. The objects or data points with the most similarities remain in the same group, and they have no or very few similarities from other groups. Clustering algorithms can be used in a variety of different tasks such as, but not limited to image segmentation, statistical data analysis, market segmentation, and the like. Some commonly used clustering algorithms that can be selected include K-means Clustering, hierarchal Clustering, DBSCAN, etc.

Association rule learning is an unsupervised learning technique which finds unique relations among variables within a large data set. In many embodiments, a primary aim of this type of learning algorithm is to find the dependency of one data item on another data item and map those variables accordingly so that it can satisfy some desired outcome. For example, in certain embodiments, an association rule system may be utilized to select a target network device for directing a collaboration session activity based on a maximized sustainability score. This algorithm can be applied in market basket analysis, web usage mining, continuous production, etc. However, those skilled in the art will recognize that other scenarios may be available based on the desired application. Some popular algorithms of association rule learning are Apriori Algorithm, Eclat, and FP-growth algorithm.

In additional embodiments, the number of features/variables present in a dataset can be understood as the dimensionality of the dataset, and the technique used to reduce the dimensionality is known as a dimensionality reduction technique. Although more data provides more accurate results, it can also affect the performance of the model/algorithm, such as yielding overfitting outcomes, etc. In such cases, dimensionality reduction techniques can be utilized. It is often desired that this process involves converting the higher dimensions dataset into lesser dimensions dataset while also ensuring that the ensuing results provide similar information. Different dimensionality reduction methods can be utilized, such as, but not limited to, PCA (Principal Component Analysis), Singular Value Decomposition (SVD), etc.

Finally, in the embodiment depicted in FIG. 10, a reinforcement learning system 1000C is shown. The reinforcement learning system 1000C can be configured with a reinforcement learning model 1060 that accepts input data 1050 and generates an output 1061. In reinforcement learning, the reinforcement learning model 1060 learns actions for a given set of states that lead to a goal state. In the embodiment depicted in FIG. 10, a critic 1080 can receive or otherwise notice an error 1070 within the reinforcement learning model 1060 actions, and adjust the outcome/output, by way of a reinforcement signal 1090, such that the “reward” or “punishment” is adjusted to better model the future behaviors or processing of the reinforcement learning model 1060.

It is a feedback-based learning model that can takes feedback signals after each state or action by interacting with the environment. This feedback works as a reward (positive for each good action and negative for each bad action), and the agent's goal is to maximize the positive rewards to improve their performance. The behavior of the model in reinforcement learning is similar to human learning, as humans learn things by experiences as feedback and interact with the environment. Popular methods of reinforcement learning including q-learning, state-action-reward-state-action (SARSA), and deep Q network.

Q-learning is one of the popular model-free algorithms of reinforcement learning, which is based on the Bellman equation. It often aims to learn the policy that can help the AI agent to take the best action for maximizing the reward under a specific circumstance. It can incorporate Q values for each state-action pair that indicate the reward to following a given state path, and it tries to maximize that Q-value.

SARSA is an on-policy algorithm based on the Markov decision process. In many embodiments, it can use the action performed by the current policy to learn the Q-value. The SARSA algorithm stands for State Action Reward State Action, which symbolizes the tuple (s, a, r, s′, a′). Finally, deep Q neural networking (or DQN) is Q-learning within a neural network. It can be deployed within a big state space environment where defining a Q-table would be a complex task. So, in these embodiments, rather than using a Q-table, the neural network instead utilizes Q-values for each action based on the state.

Although a specific embodiment for different methods of machine-based learning suitable for carrying out the various steps, processes, methods, and operations described herein is discussed with respect to FIG. 10, any of a variety of systems and/or processes may be utilized in accordance with embodiments of the disclosure. For example, those skilled in the art will recognize that methods of learning described herein are generalized and may incorporate other types developed as well as a combination of one or more methods based on the goals of the desired application. The elements depicted in FIG. 10 may also be interchangeable with other elements of FIGS. 1-9 and 11-18 as required to realize a particularly desired embodiment.

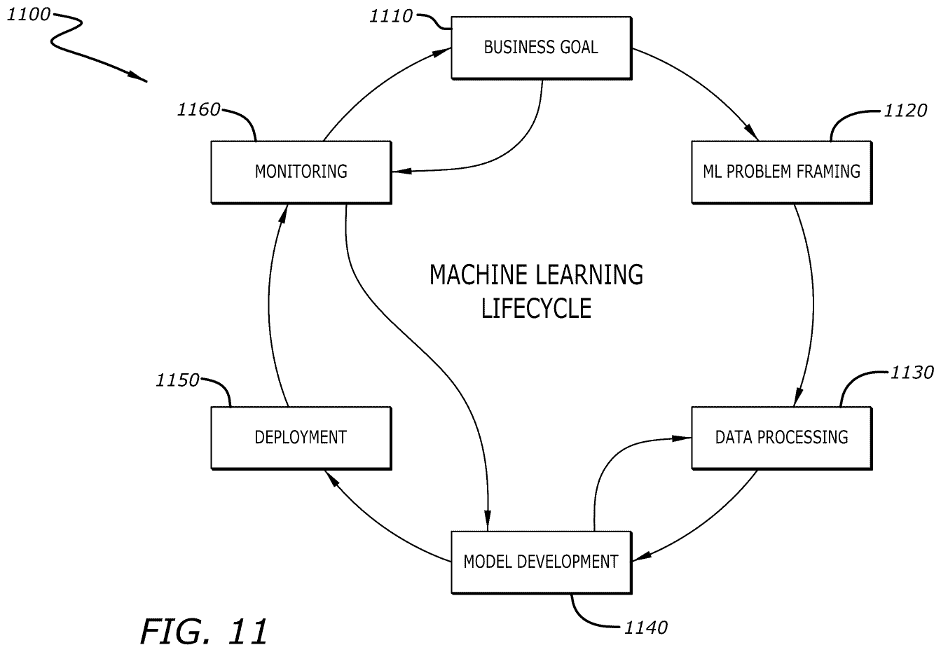

Referring to FIG. 11, a machine learning lifecycle 1100 in accordance with various embodiments of the disclosure is shown. During the development of machine learning systems, the embodiment depicted in FIG. 11 can provide a framework for how to structure the design and maintenance of these systems. This machine learning lifecycle 1100 outlines various stages involved in building, deploying, and improving ML models to solve real-world problems. By following this structured process, businesses and organizations can ensure that their machine learning projects align with strategic goals, use data effectively, and adapt to changing conditions over time. This machine learning lifecycle 1100 emphasizes that developing a machine learning model is not a one-time effort but an iterative process requiring ongoing monitoring and adjustment. The feedback loop inherent in the machine learning lifecycle 1100 allows for continual refinement and optimization of models to maintain their accuracy and relevance.

In many embodiments, a first stage of the machine learning lifecycle 1100 is identifying the business goal 1110, which sets the overall direction and purpose of the ML project. This can involve understanding the specific problems or opportunities within the business or project that machine learning can address. A clear business goal 1110 ensures that the project remains focused on delivering tangible value, whether it is determining sustainability scores of network devices, selecting the most sustainable target network device, or predicting values of sustainability attributes for certain network devices. Without a well-defined goal, it can be challenging to align the subsequent stages of the ML lifecycle 1100, as the choice of model, data processing methods, and performance metrics can all depend on what the business aims to achieve.

Establishing a proper business goal 1110 can also involve engaging with key stakeholders and developers to gather requirements and set success criteria. It can provide a roadmap that outlines what success looks like and helps in framing the ML problem. For example, if the goal is to maximize utilization rate of network devices with low carbon footprint, the project might focus on building a predictive model that assigns a higher weightage to carbon footprint and the utilization rate. Clearly defined goals not only help guide the project but also provide benchmarks for evaluating the effectiveness of the deployed model once it enters production.

Once the business goal 1110 is established, various embodiments take a next step involving ML problem framing 1120, wherein the goal is translated into a specific machine learning task. This can involve selecting the appropriate type of ML problem, such as classification, regression, clustering, or recommendation, and defining the target variables or outputs. For example, if the goal is to determine sustainability scores based on a set of sustainability attributes and a set of non-sustainability attributes, the problem can be framed as a binary classification task where the model predicts whether a particular value an attribute will positively or negatively impact the sustainability score. Proper problem framing can be important as it determines the particular data requirements, choice of model, and evaluation metrics.

During this stage, it is also prudent to consider the constraints and assumptions that may affect the model's development. This might include data availability, computational resources, ethical considerations, or regulatory compliance. Properly framing the problem ensures that the model development aligns with the business's needs and that the problem is broken down into manageable steps, ultimately increasing the project's chances of success.

Data processing 1130 is a step in many embodiments where raw data is collected, cleaned, and transformed into a format suitable for machine learning. This step can involve gathering data from various sources, removing errors or inconsistencies, handling missing values, and normalizing or scaling features to ensure that the model can learn effectively. Feature engineering is often a part of this stage, where new features are derived from the raw data to capture more relevant information and improve model performance.

The quality and preparation of the utilized data can significantly impact the model's accuracy and reliability. Inadequate or poorly processed data can lead to biased or inaccurate predictions, no matter how advanced the model is. Hence, data processing 1130 can require or at least benefit from careful planning and iterative refinement. Once the data is processed, it is typically split into training, validation, and test sets to develop and evaluate the model, ensuring that it generalizes well to new, unseen data.

Model development 1140 is a phase in a number of embodiments where machine learning algorithms are selected, trained, and refined to create a model that addresses the framed problem. This stage can involve choosing the appropriate algorithm (e.g., decision trees, neural networks, support vector machines), setting up the model's architecture, and defining hyperparameters that will guide the training process. The model is trained on the processed data to identify patterns and relationships that allow it to make predictions or decisions.

During model development 1140, the model can be evaluated using the validation dataset to fine-tune its parameters and improve performance. Techniques like cross-validation, regularization, and hyperparameter tuning can be used to prevent overfitting and ensure the model generalizes well. If proper steps are taken, the result is a model that, once it meets predefined performance metrics, is ready for deployment in a real-world environment. However, this process often involves several iterations to optimize the model for the specific business goal, indicated by the arrow back to data processing 1130.

In further embodiments, deployment 1150 is the stage where the developed model is integrated into the production environment to perform its intended tasks. This phase may involve setting up the necessary infrastructure, such as APIs or cloud-based services, to allow the model(s) to process live data and generate predictions. Deployment 1150 can transform the model from a research tool into a functional component of a business process or product, providing real-time insights, automations, or decisions.

Proper deployment 1150 can also include setting up mechanisms for logging, error handling, and user access. Since real-world environments are often dynamic and differ from training conditions, deployment may require continuous adaptation and updates to ensure the model(s) operates efficiently. This step can be important because a model's success is not only determined by its performance metrics but also by its ability to provide actionable results that align with the business goal 1110.

In more embodiments, monitoring 1160 is the ongoing process of tracking the model's performance and behavior after deployment. It involves collecting data on the model's predictions, accuracy, latency, and error rates to detect issues such as concept drift, where changes in the underlying data patterns can degrade the model's accuracy. By continuously monitoring 1160, teams can identify when the model's performance drops and requires retraining or adjustments to align with the evolving data.

Monitoring 1160 can also encompass aspects like user feedback, security, and compliance, ensuring that the model remains effective, reliable, and ethical in its application. It may serve as the feedback loop in the lifecycle, where insights gained from monitoring feed back into the earlier stages, particularly data processing 1130 and model development 1140, to refine the model(s) as needed. This iterative process allows the machine learning system to adapt and maintain its alignment with the original business goal 1110 over time.

Although a specific embodiment for a machine learning lifecycle 1100 suitable for carrying out the various steps, processes, methods, and operations described herein is discussed with respect to FIG. 11, any of a variety of systems and/or processes may be utilized in accordance with embodiments of the disclosure. For example, the particular route of development of the model(s) may not follow this cycle completely. As those skilled in the art will recognize, there are a variety of ways to develop AI products that include various iterative steps that aide in development and refinement of different model(s). The elements depicted in FIG. 11 may also be interchangeable with other elements of FIGS. 1-10 and 12-18 as required to realize a particularly desired embodiment.

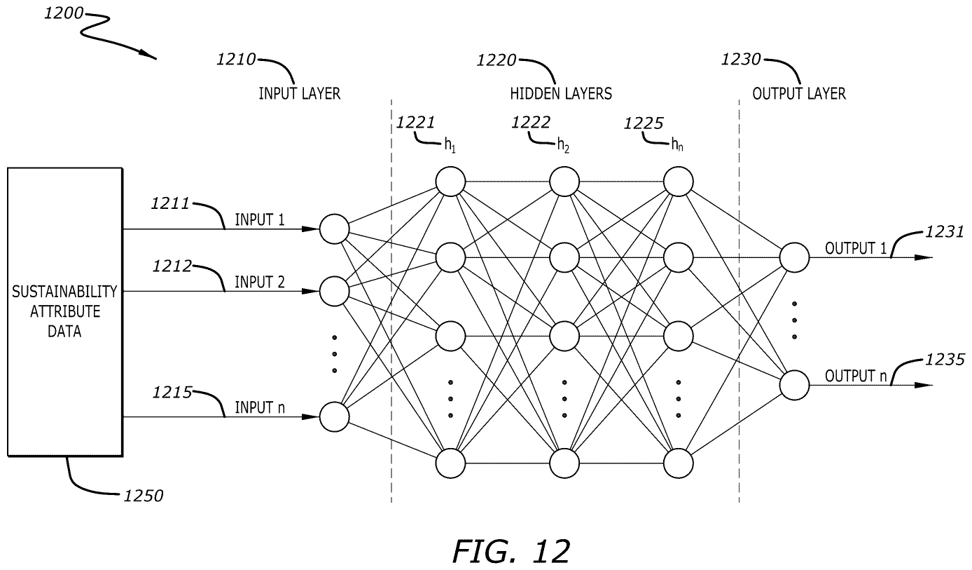

Referring to FIG. 12, an exemplary neural network 1200 in accordance with various embodiments of the disclosure is shown. The embodiment depicted specifically depicts a feedforward neural network with multiple layers. This type of network consists of an input layer 1210, one or more hidden layers 1220, and an output layer 1230. Each layer contains nodes (or neurons) that are interconnected, representing how data flows through the network. The input layer 1210 can receive raw data, which is then processed by the hidden layers 1220 through weighted connections and activation functions. These hidden layers 1220 can enable the network to learn complex patterns and relationships within the data.

The final output layer 1230 produces the network's predictions or classifications based on the processed input. The interconnected nature of the nodes allows the neural network 1200 to learn from data during training by adjusting the weights of connections to minimize prediction errors. This structure is the foundation of deep learning models, as adding more hidden layers 1220 can create a deep neural network, capable of tackling highly complex tasks such as image recognition, natural language processing, and pattern detection in large datasets.

A perceptron or a single artificial neuron is the building block of artificial neural networks (ANNs) and can perform forward propagation of information. For a set of inputs to the perceptron, weights (and biases to shift wights) can be assigned. These inputs and weights can be multiplied out correspondingly together to get a sum output. Those skilled in the art will recognize tools such as, but not limited to, PyTorch, Tensorflow, and MXNet as training packages for common neural network tasks. However, it is contemplated that other tools may be developed specifically for the neural network tasks related to the embodiments described herein.

In additional embodiments, the weight matrices of a neural network can be initialized randomly or obtained from a pre-trained model. These weight matrices can be multiplied with the input matrix (or output from a previous layer) and subjected to a nonlinear activation function to yield updated representations, which are often referred to as activations or feature maps. The loss function (also known as an objective function or empirical risk) can often be calculated by comparing the output of the neural network and the known target value data.

Feedforward networks, such as the neural network 1200 depicted in the embodiment of FIG. 12, are often configured as neural networks where information moves in one direction, from the input layer through the hidden layers to the output layer, without any cycles or loops. They are primarily used for tasks such as classification, regression, and simple pattern recognition, where each input is processed independently of others. In contrast, backpropagation is not a separate type of network but rather a training algorithm commonly used in both feedforward and other types of networks, like recurrent neural networks (RNNs).

Backpropagation involves adjusting the weights of the network in the reverse direction (from output to input) based on the error between the predicted output and the actual target during training. While feedforward describes the structure and data flow within the network, backpropagation is a technique used to optimize the model. Feedforward networks are ideal for straightforward tasks where input-output relationships are not sequential or time-dependent. However, for problems involving learning complex patterns over time, such as routing decisions based on dynamic changes in sustainability scores or time-series analysis, networks that leverage backpropagation for training, like RNNs or deep feedforward networks with many hidden layers, become necessary to capture these intricate dependencies.

Typically, in these network arrangements, the weights are iteratively updated via various methods including, but not limited to, stochastic gradient descent algorithms in order to help minimize the loss function until the desired accuracy is achieved. Most modern deep learning frameworks can facilitate this by using reverse-mode automatic differentiation to obtain the partial derivatives of the loss function with respect to each network parameter through recursive application of the chain rule. Colloquially, this is also known as back-propagation. Common gradient descent algorithms can include, but are not limited to, Stochastic Gradient Descent (SGD), Adam, Adagrad etc. The learning rate is an important parameter in gradient descent. Except for SGD, all other methods use adaptive learning parameter tuning. Depending on the objective such as classification or regression, different loss functions such as Binary Cross Entropy (BCE), Negative Log Likelihood Loss (NLLL) or Mean Squared Error (MSE) can be used.

Neural network architecture is commonly used for a wide range of tasks in fields such as computer vision, natural language processing, financial forecasting, and materials science. For instance, it can be employed to recognize patterns in images, such as identifying objects or faces, or to classify text into categories, like spam detection in emails. It is also useful in regression problems, such as predicting stock prices or energy consumption, where input features can be processed to output continuous values. However, this is a general example of an artificial intelligence (AI) model, illustrating how a feedforward neural network works. Depending on the problem, other methods and models may be more appropriate. For example, convolutional neural networks (CNNs) are often used for image processing tasks, while recurrent neural networks (RNNs) are suitable for sequential data like time series data or text. Additionally, simpler models like linear regression, decision trees, or support vector machines (SVMs) may be sufficient if the problem is less complex, or the dataset is relatively small. The embodiment depicted in FIG. 12 is presented as an exemplary ML solution that may be deployed within one or more methods or systems described herein.

In many embodiments, the input layer 1210 is the first layer in a neural network 1200 and serves as the initial point where raw data is introduced into the model. Each node (or neuron) in this layer represents an individual feature or variable from the dataset, allowing the network to receive and process various types of data, such as pixel values in an image, numerical features (e.g., KPIs of network device) in a spreadsheet, or words in a text document. For instance, determining sustainable network devices, the input layer can consist of nodes that may process features like battery level, signal strength, and energy efficiency and provide optimal routing choices by identifying network devices that can handle traffic while minimizing energy consumption. The number of nodes in the input layer directly depends on the number of features present in the dataset. If there are one-hundred features in the data, the input layer will typically have one-hundred nodes, each conveying one piece of the information to the subsequent layers. In more embodiments, the inputs of the neural network 1200 are generally scaled i.e., normalized to have a zero mean and/or unit standard deviation. Scaling can also be applied to the input of hidden layers (using batch or layer normalization) to improve the stability of neural network 1200.

Unlike the hidden layers 1220 and output layers 1230, the input layer 1210 typically does not perform any computations or transformations on the data. Its primary function is often to pass the input data to the next layer in the network, the first hidden layer 1221. However, it is often desired that the data fed into this layer is preprocessed appropriately, such as being normalized or standardized, to ensure that the neural network can learn efficiently. Proper preprocessing, like scaling numerical values or encoding categorical variables, can help the network process data uniformly, facilitating more stable and faster convergence during training.

The input layer's design depends on the nature of the problem. For example, in natural language processing, the input layer may represent words encoded as numerical vectors, while in time-series analysis, each node might represent a data point in a sequence. While the input layer 1210 itself does not modify the data, it sets the stage for the neural network to extract complex patterns and relationships through the deeper layers. This flexibility in handling various types of input make the neural network 1200 a powerful tool for a diverse set of applications.

With respect to the embodiments described herein, the input layer may be configured with a plurality of inputs providing sustainability attribute data 1250. For example, a model can be configured with a first input 1211 configured as a first sustainability attribute, a second input 1212 is configured with a second sustainability attribute, while additional inputs can be added related to the number of potential sustainability attributes. The nth input 1215 can be configured in certain embodiments to include an N^{th} sustainability attribute. Examples of the sustainability attributes can include, but not limited to, an operational status, a utilization rate, energy consumption, an energy source, a grid reliability, a carbon footprint, a regional carbon intensity, or a power usage effectiveness of a network device. However, as those skilled in the art will recognize that the inputs can be configured to also include non-sustainability attribute data, among other input types, etc.

In a number of embodiments, the neural network 1200 comprises a plurality of hidden layers 1220. The embodiment depicted in FIG. 12 comprises a first hidden layer 1221, a second hidden layer 1222, and an nth hidden layer 1225, which are denoted as h₁, h₂, and hₙ respectively. In many embodiments, the hidden layers 1220 are where the core of the model's learning and pattern recognition occurs. In each hidden layer, individual neurons receive inputs from the previous layer, apply a set of weights, add a bias, and pass the result through an activation function (e.g., ReLU, leaky ReLU, sigmoid, hyperbolic tangent (tanh), Swish, etc.). This process can introduce non-linearity, allowing the network to capture complex patterns in the data that simple linear models cannot. The intricate web of connections among neurons across layers helps the network transform and process input features into representations that become progressively more abstract and useful for making predictions.

The first hidden layer 1221 h₁ receives direct input from the input layer, transforming the raw data into an initial set of features. For example, in an image recognition task, this layer might begin identifying basic patterns, such as edges or simple textures. The output of the first hidden layer 1221 is then passed to a second hidden layer 1222 h₂, which builds upon the features identified by the first hidden layer 1221. This deeper layer might start recognizing more complex patterns, such as shapes or specific object components, by combining the lower-level features identified earlier. This can continue on until a last, nth hidden layer 1225 hₙ continues this abstraction process, allowing the network to recognize even higher-level, more detailed features, such as identifying an entire object within an image or understanding intricate relationships in the input data.

Each hidden layer adds a level of complexity and abstraction to the network's learning capabilities. The multi-layer structure can enable the network to move from recognizing simple patterns in the first input layer 1221 to highly complex, abstract concepts in the deeper layers. The number of hidden layers and neurons within them can vary depending on the problem's complexity. More hidden layers generally allow the network to model more intricate functions, making deep neural networks especially effective for tasks like image recognition, natural language processing, complex predictive modeling and sustainable device prediction for routing traffic. However, adding more layers also increases the computational demand and the risk of overfitting, highlighting the need to carefully design and tune these hidden layers for optimal performance.

In various embodiments, the output layer 1230 is often the final layer in a neural network and is responsible for producing the network's predictions or classifications based on the information processed through the previous hidden layers 1220. Each neuron in the output layer 1230 can represent a specific outcome or category that the model can predict. In the embodiment depicted in FIG. 12, the outputs are labeled as “output 1” 1231 to “output n” 1235, indicating that the network can be designed to have a varying number of outputs depending on the nature of the problem being solved for. For example, in a binary classification task (e.g., sustainable device vs. non-sustainable device), there would typically be a single output neuron that provides a probability score for one of the two classes/outcomes. In contrast, for multi-class classification (e.g., selecting a most sustainable network device between three or more potential network devices), the output layer would contain multiple neurons, each corresponding to a different class.

The number of neurons in the output layer 1230 can also designed specifically for other types of tasks, such as regression, where the model can predict continuous values. In such cases, the output layer 1230 might contain a single neuron representing a numerical prediction, such as the price of a house or the temperature forecast, etc. Alternatively, in complex applications like multi-label classification (where each input can belong to multiple classes simultaneously), the output layer 1230 could have multiple neurons, each representing a different class, with each neuron outputting a probability of the input belonging to that specific class.

The activation function used in the output layer can vary based on the desired output. For binary classification, a sigmoid function is commonly used to produce a probability between 0 and 1. For multi-class classifications, a softmax function can be applied to output a set of probabilities that sum to 1, indicating the most likely class. For regression problems, a linear activation function is often used to output a continuous range of values. The flexibility in designing the output layer allows the neural network 1200 to be applied to a wide variety of tasks, from simple binary decisions to complex multi-output predictions, making them a versatile tool in artificial intelligence and machine learning.

In several additional embodiments, a communication management device may utilize the neural network 1200 to automate sustainability-related collaboration session-activity routing decisions, making a communication network more energy-efficient, adaptive, and capable of minimizing its carbon footprint while maintaining performance. For example, if the communication management device detects a rise in carbon intensity in a certain geographic region, the neural network 1200 can automatically shift collaboration session activities to a region with lower emissions or better renewable energy availability. Similarly, the neural network 1200 can identify periods of low device utilization and automatically indicate which network devices to put in sleep mode or power down, optimizing energy consumption without manual intervention. The neural network 1200 can evaluate sustainability scores of multiple network devices and select the most eco-friendly route for a collaboration session or communication activity. This could involve selecting a server or a gateway device that is closer geographically, has lower energy consumption, or is powered by renewable energy sources. Over time, the neural network 1200 can adjust routing algorithms based on feedback, improving the sustainability efficiency of the communication network without compromising performance.

Although a specific embodiment for an exemplary neural network suitable for carrying out the various steps, processes, methods, and operations described herein is discussed with respect to FIG. 12, any of a variety of systems and/or processes may be utilized in accordance with embodiments of the disclosure. For example, real-world neural networks are often far more complex, featuring many more layers, nodes, and connections than the simplified structure shown in the embodiment depicted in FIG. 12, which is an illustrative example meant to make it easier to explain the basic concepts of neural networks and how they process information. The specific features and functions described herein are not intended to be limiting to this specific embodiment. Additionally, the elements depicted in FIG. 12 may also be interchangeable with other elements of FIGS. 1-11 and 13-18 as required to realize a particularly desired embodiment.

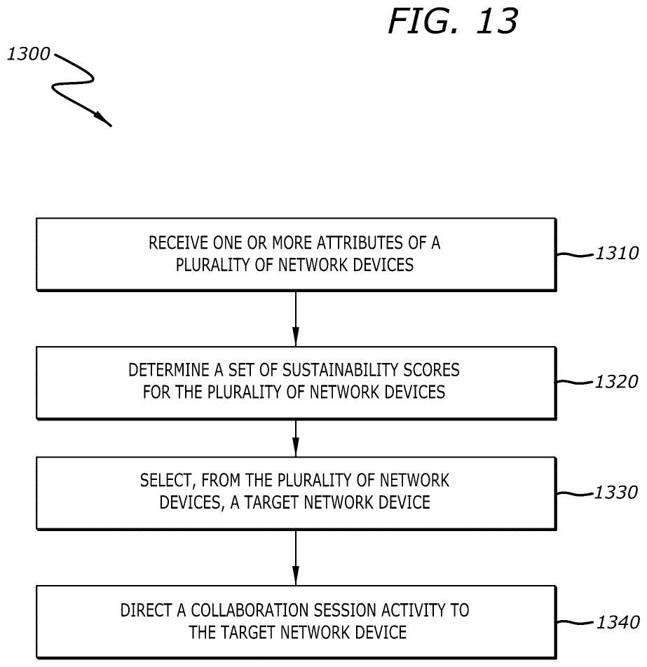

Referring to FIG. 13, a flowchart depicting a process for directing collaboration session activities based on sustainability awareness in accordance with various embodiments of the disclosure is shown. A communication network may include a communication management device communicatively coupled to a plurality of network devices and a plurality of end-user devices. In many embodiments, the process 1300 may receive one or more attributes of the plurality of network devices (block 1310). The attributes may include, for example, KPIs associated with power consumption, geographic location, current load, energy efficiency, carbon intensity or energy consumption patterns over time, or the like of the network devices. The one or more attributes may also capture KPIs regarding the operational state of each network device, such as whether the network device is powered on, idle, or in sleep mode. In one or more embodiments, the one or more attributes may include a set of sustainability attributes, for example, an operational status, a utilization rate, energy consumption, an energy source, a grid reliability, a carbon footprint, a regional carbon intensity, or a power usage effectiveness. In various embodiments, the one or more attributes may additionally include a set of non-sustainability attributes, for example, latency, bandwidth, packet loss rate, uptime, jitter, or other performance related parameters.

In a variety of embodiments, the process 1300 may determine a set of sustainability scores for the plurality of network devices (block 1320). In other words, the process 1300 may determine a sustainability score for each of the network devices based on the received one or more attributes. The sustainability score may be determined using an algorithm that takes into account multiple attributes such as carbon footprint, energy consumption, server utilization, geographical energy sourcing (e.g., renewable vs non-renewable energy), or the like and their impact on sustainability. In other words, the sustainability score (e.g., green score, carbon footprint score) may be a complex metric determined by the KPIs acquired from the network devices through a collaboration session control transport mechanism (e.g., collaboration session messages or keep alive pings). The plurality of the network devices may be sorted based on the sustainability scores. For example, in one scenario, a higher sustainability score may indicate a more sustainable or energy-efficient device, while a lower sustainability score may indicate higher energy usage or carbon footprint. In another example, a higher sustainability score may indicate higher energy usage or carbon footprint while a lower sustainability score may indicate a more sustainable or energy-efficient device.

In a variety of embodiments, the process 1300 may select, from the plurality of network devices, a target network device (block 1330). In other words, the process 1300 may utilize the set of sustainability scores to select the most sustainable target network device to direct a collaboration session activity. In a non-limiting example, the process 1300 may select a gateway device A for routing an incoming VoIP collaboration session based on its high sustainability score (130) as compared to another gateway device B having a low sustainability score (80).

In still additional embodiments, the process 1300 may direct a collaboration session activity to the target network device (1340). In other words, after selecting the target network device, the process 1300 may route the collaboration session activity to the selected target network device. This could involve directing a voice, video, or data session through the selected, energy-efficient target network device. Other examples of collaboration session activities may include session control operations and device registration operations. Example of various collaboration session control operations may include collaboration session authentication and authorization, Quality of Service management, session feature management such as session hold, transfer, forwarding, session transaction management, or the like.

Although a specific embodiment for directing a collaboration session activity to a network device based on sustainability awareness suitable for carrying out the various steps, processes, methods, and operations described herein is discussed with respect to FIG. 13, any of a variety of systems and/or processes may be utilized in accordance with embodiments of the disclosure. For example, the process 1300 may select the target network device based on one or more rules associated with an incoming collaboration session initiated by an end-user device. The elements depicted in FIG. 13 may also be interchangeable with other elements of FIGS. 1-12 and 14-18 as required to realize a particularly desired embodiment.

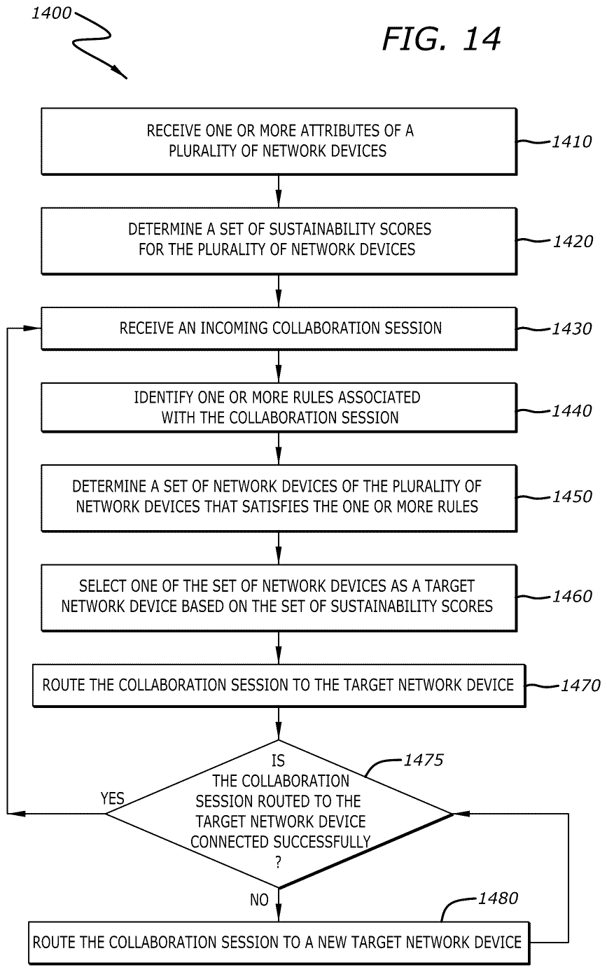

Referring to FIG. 14, a flowchart depicting a process 1400 for directing a collaboration session activity to a network device based on sustainability awareness in accordance with various embodiments of the disclosure is shown. The process 1400 may be performed at a session controller (e.g., a communication management device) communicatively coupled to a plurality of network devices (e.g., routers, gateway devices, bridges, or the like) and a plurality of end-user devices. In many embodiments, the process 1400 may receive one or more attributes of the plurality of network devices (block 1410). The one or more attributes may include real-time energy consumption, CPU utilization, device location, carbon footprint, and other sustainability-related metrics. The attribute collection process may be continuous or triggered by specific events to keep the process 1400 up-to-date with current sustainability conditions across the network.

In a variety of embodiments, the process 1400 may determine a set of sustainability scores for the plurality of network devices (block 1420). Once the attributes are received, the process 1400 may utilize the received attributes to calculate a sustainability score for each network device of the plurality of network devices. The sustainability scores (also referred to as green scores) may reflect the environmental impact of utilizing each network device, considering factors such as energy efficiency, carbon emissions, availability of renewable energy, or the like.

In a number of embodiments, the process 1400 may receive an incoming collaboration session (block 1430). A source end-user device may initiate a collaboration session that needs to be routed through a network device to a destination end-user device. The process 1400 may select which network device should handle the collaboration session, considering both traditional routing rules and sustainability considerations. The incoming collaboration session triggers a sustainability aware session control logic, where the process 1400 may evaluate how best to route the collaboration session from sustainability standpoint without comprising Quality of Service.

In a variety of embodiments, the process 1400 may identify one or more rules associated with the incoming collaboration session (block 1440). The one or more rules may refer to traditional routing rules or parameters that may apply to the routing of the incoming collaboration session. The rules may be based on a collaboration session type, a priority, a geographic region, a dialed number, or specific user preferences, among others. For example, certain collaboration sessions may need to be routed through specific gateways due to security requirements, or priority sessions may need to be routed through gateways with faster processing capabilities.

In numerous embodiments, the process 1400 may determine a set of network devices of the plurality of network devices that satisfies the one or more rules (block 1450). The set of network devices may form a route list comprising one or more route groups. That is to say, the process 1400 may evaluate which network devices among the plurality of network devices satisfy the identified rules. In other words, the process 1400 may filter the plurality of network devices based on the identified rules and obtain the route list comprising the one or more route groups. Network devices in a route group may share similar characteristics or serve a common function within the network, such as handling a particular type of session or serving a particular region. The route groups may be further arranged in a prioritized sequence, defining the order in which the route groups should be considered when routing the incoming collaboration session.

In further embodiments, the process 1400 may select one network device of the set of network devices as a target network device based on the set of sustainability scores (block 1460). In other words, in the routing list, the process 1400 may first select a route group that has the highest priority and then select the target network device that has the best or most optimal sustainability score in the selected route group. The network device having the optimal sustainability score and that also satisfies the identified rules may be selected as the target network device.

In still additional embodiments, the process 1400 may route the incoming collaboration session to the target network device (block 1470). The collaboration session may be established using the available communication protocols (e.g., SIP or PSTN). By routing the collaboration session to the most sustainable network device, the process 1400 may optimize resource usage while meeting the operational needs of the collaboration session. In other words, the routing decision is based on both traditional collaboration sessions routing logic and sustainability scores of the network devices.

In still further embodiments, the process 1400 may determine whether the incoming collaboration session routed to the target network device is connected successfully (block 1475). The process 1400 may confirm that the collaboration session connection has been properly established, and no errors or interruptions have occurred. If the collaboration session is successfully connected, the process 1400 may return to the initial state (block 1410), ready to receive and process new sessions.

However, in response to determining that the collaboration session connection has failed, in yet more embodiments, the process 1400 may re-route the incoming collaboration session to a new target network device (block 1480). The new target network device may be selected from the remaining pool of network devices in the set of network devices based on the same set of sustainability scores and routing rules. The process 1400 may be repeated until the collaboration session is successfully connected or the routing options are exhausted.

Although a specific embodiment directing a collaboration session activity to a network device based on sustainability awareness suitable for carrying out the various steps, processes, methods, and operations described herein is discussed with respect to FIG. 14, any of a variety of systems and/or processes may be utilized in accordance with embodiments of the disclosure. For example, the process 1400 may re-route active collaboration session activities to a more suitable network device if there is any change in the attributes of the current target network device through which the collaboration session activity is currently being routed. The elements depicted in FIG. 14 may also be interchangeable with other elements of FIGS. 1-13 and 15-18 as required to realize a particularly desired embodiment.

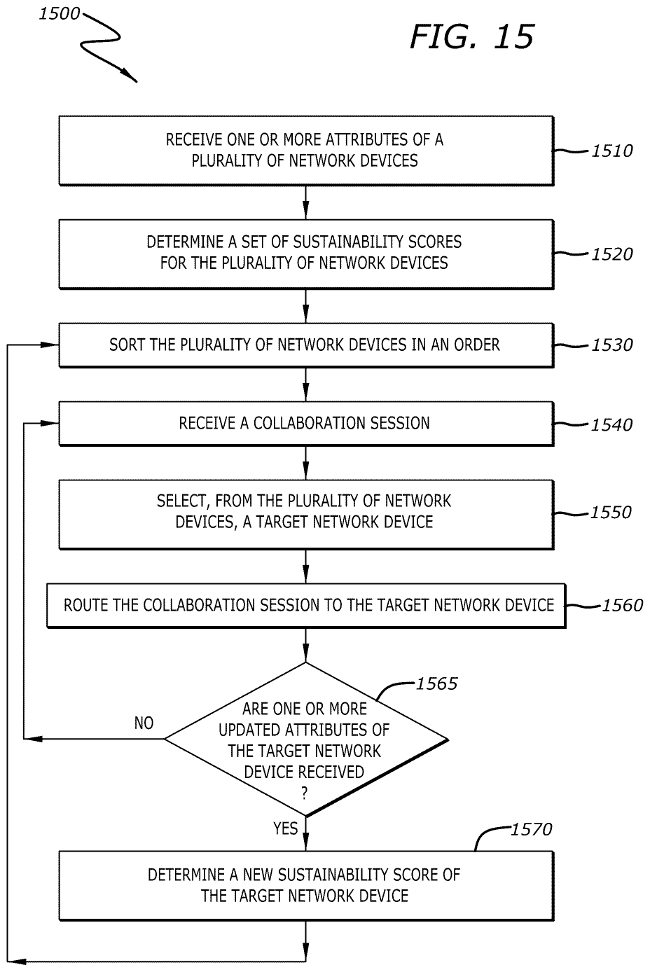

Referring to FIG. 15, a flowchart depicting a process 1500 for routing an incoming collaboration session to a network device based on sustainability awareness in accordance with various embodiments of the disclosure is shown. The process 1500 may be performed at a network resource that can run an associated software stack for collaboration session routing. For example, the process 1500 may be performed at a session controller communicatively coupled to a plurality of network devices and a plurality of end-user devices. In many embodiments, the process 1500 may receive one or more attributes of the plurality of network devices (block 1510). Examples of the plurality of network devices may include routers, gateways, bridges, switches, firewalls, or the like. The received attributes may include a set of sustainability attributes, for example, an operational status, a utilization rate, energy consumption, an energy source, a grid reliability, a carbon footprint, a regional carbon intensity, or a power usage effectiveness energy consumption, carbon footprint, geographic location, or any other parameter that may have an impact on sustainability. In one or more embodiments, the received attributes may further include a set of non-sustainability attributes, for example, latency, bandwidth, packet loss rate, uptime, jitter, or other performance related parameters.

In a variety of embodiments, the process 1500 may determine a set of sustainability scores for the plurality of network devices (block 1520). Based on the received attributes, the process 1500 may determine a respective sustainability score for each network device. In certain embodiments, the determined sustainability scores may also be referred to as green scores. In some embodiments, the determined sustainability scores may also be referred to as carbon footprint scores. Each sustainability score may be a quantitative assessment that reflects the environmental impact of running the corresponding network device.

In a number of embodiments, the process 1500 may sort the plurality of network devices in an order (block 1530). Once the set of sustainability scores are determined, the plurality of network devices may be sorted in a descending order or an ascending order of their sustainability scores. In other words, the more sustainable network devices are prioritized over less sustainable network devices for collaboration session routing purposes.

In a variety of embodiments, the process 1500 may receive an incoming collaboration session (block 1540). For example, the incoming collaboration session may have been initiated by a source end-user device and need to be routed through a network device to a destination end-user device. In various embodiments, the incoming collaboration session can include voice, audio, video, and/or data communications over IP networks, for example, networks based on SIP or H.323 protocols. In various additional embodiments, the incoming collaboration session can be an internal (on-net) collaboration session, which is to be routed within an organization's network, for example, between employees using IP phones or softphones. In some more embodiments, the incoming collaboration session can be an external (off-net) collaboration session to connect an internal device to the PSTN or an SIP trunk. In such embodiments, the destination end-user device may lie outside the organization's network. Further examples of the incoming collaboration session can include, but not limited to, voicemail sessions, conference call sessions, emergency call sessions, file sharing sessions, or the like.

In numerous embodiments, the process 1500 may select, from the plurality of network devices, a target network device (block 1550). The process 1500 may select the target network device that satisfies one or more rules associated with the incoming collaboration session, has the most optimal sustainability score among the plurality of network devices, and exhibits the capability to handle the incoming collaboration session. Examples of the one or more rules may include a COS, a collaboration session type (e.g., local, international, or toll-free), caller profile, or the like. In an example, the process 1500 may select one such network device that has the highest sustainability score among those that satisfy the one or more rules associated with the incoming collaboration session and are capable of handling the incoming collaboration session.

In further embodiments, the process 1500 may route the incoming collaboration session to the target network device (block 1560). After selecting the target network device, the process 1500 may route the incoming collaboration session to the selected target network device. The process 1500, thus, may ensure that the incoming collaboration session is handled efficiently while maximizing sustainability goals, such as reducing energy consumption, leveraging low-carbon regions, or the like. The process 1500 can further monitor whether the collaboration session is successfully connected or not.

In still further embodiments, the process 1500 may determine whether one or more updated attributes of the target network device are received (block 1565). During an ongoing collaboration session, KPIs, such as energy consumption, network load, latency, resource utilization, and the set of sustainability attributes, of the target network device may be monitored. If any of the KPIs change, such as an increase in energy usage, a drop in available bandwidth, an increase in carbon footprint, etc, the process 1500 may receive the one or more updated attributes of the network device. The process 1500 may then re-evaluate the target network device's sustainability score and determine whether to continue routing the collaboration session through the target network device or redirect it to a more optimal network device. If no updated attributes are received, the process 1500 may continue receiving new incoming collaboration sessions (block 1530).

However, if the one or more updated attributes are received, in yet more embodiments, the process 1500 may determine a new sustainability score of the target network device (block 1570). That is to say, when new attributes are received, the process 1500 may determine the new sustainability score for the target device to ensure that it reflects the real-time conditions. For example, a network device may be initially selected for routing a collaboration session based on its optimal sustainability score. However, during the collaboration session, the energy consumption of the network device unexpectedly increases due to higher-than-anticipated network traffic, causing the sustainability score of the network device to decrease. Upon receiving the new attributes, the process 1500 may determine the updated sustainability score of the network device. This real-time adjustment may ensure that future collaboration sessions are routed to network devices with the best sustainability posture, preventing inefficient or less sustainable devices from continuing to handle collaboration sessions. The process 1500 may re-sort the plurality of network devices based on updates to the sustainability scores (block 1530).

Although a specific embodiment directing a collaboration session activity to a network device based on sustainability awareness suitable for carrying out the various steps, processes, methods, and operations described herein is discussed with respect to FIG. 15, any of a variety of systems and/or processes may be utilized in accordance with embodiments of the disclosure. For example, the process 1500 may re-route the incoming collaboration session to a new target network device if the new sustainability score of the previously selected target network device becomes non-optimal. The elements depicted in FIG. 15 may also be interchangeable with other elements of FIGS. 1-14 and 16-18 as required to realize a particularly desired embodiment.

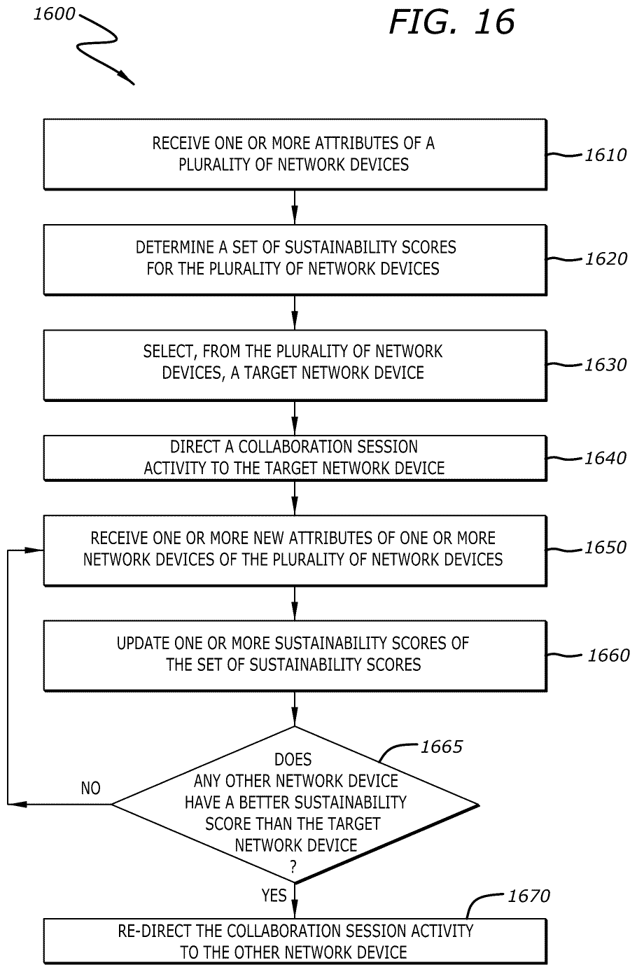

Referring to FIG. 16, a flowchart depicting a process 1600 for updating sustainability scores in accordance with various embodiments of the disclosure is shown. The process 1500 may be performed at a network resource that can run an associated software stack for collaboration session activity routing. Examples of the network resource can include a session controller, a collaboration device, a media transaction server, a media termination server, a software conference bridge, a media session processing server, or device registration server, a communications manager, a call controller, or the like. The network resource may be communicatively coupled to a plurality of network devices and a plurality of end-user devices. In many embodiments, the process 1600 may receive one or more attributes of the plurality of network devices (block 1610). Examples of the plurality of network devices may include routers, gateways, bridges, switches, firewalls, or the like. Values of the one or more attributes can be received from the plurality of network devices or from a sustainability controller in communication with the plurality of network devices. The received attributes may include a set of sustainability attributes that has an impact on sustainability. In more embodiments, the received attributes may further include a set of non-sustainability that relate to device's performance aspects. In further embodiments, some of the one or more attributes can also be received from one or more external data sources. In one or more embodiments, the process 1600 may receive the values of the one or more attributes for each network device in the form of an N-dimensional feature vector.

In a variety of embodiments, the process 1600 may determine a set of sustainability scores for the plurality of network devices (block 1620). That is to say, based on the received attributes, the process 1600 may determine a sustainability score for each network device. In various embodiments, the set of sustainability scores may be determined by utilizing various ML/AI models. In various additional embodiments, the process 1600 may utilize one or more statistical aggregation techniques, such as weighted sum, weighted average, weighted rolling mean, or the like, on the values of the received attributes to determine the set of sustainability scores. In statistical aggregation techniques can be applied based on a sustainability policy that assigns specific weights to each attribute. In certain embodiments, the process 1600 may apply various data cleaning, processing, and normalization operations on the values of the received attributes, prior to determining the set of sustainability scores. For example, the network devices may monitor their sustainability performance and record attribute values. However, different network devices may utilize different metric systems to record these attribute values. Therefore, the process 1600 may need to standardize the attribute values upon receiving them, for example, by format conversion.

In a number of embodiments, the process 1600 may select, from the plurality of network devices, a target network device (block 1630). In other words, once sustainability scores are determined, the process 1600 may select one network device as the target network device for a current communication activity. The target network device may be selected based on its sustainability score being more optimal than the sustainability scores of other peer network devices.

In more embodiments, the process 1600 may direct a collaboration session activity to the target network device (block 1640). In numerous embodiments, directing the collaboration session activity may include routing an incoming collaboration session or session control operations of the incoming collaboration session to the target network device. In numerous additional embodiments, directing the collaboration session activity may include directing a device registration request to the target network device.

In still more embodiments, the process 1600 may receive one or more new attributes of one or more network devices of the plurality of network devices (block 1650). During or after the collaboration session activity, the process 1600 may receive attribute updates from the one or more network devices. For example, the one or more network devices may update the values of the one or more attributes. The one or more new attributes may be received by the network resource managing the plurality of network devices.

In yet more embodiments, the process 1600 may update one or more sustainability scores of the set of sustainability scores (block 1660). Using the newly received one or more attributes, the process 1600 may re-determine the sustainability scores for relevant network devices. For example, if among five network devices, the one or more new attributes of two network devices are received, the process 1600 may update the sustainability scores of the two network devices.

In additional embodiments, the process 1600 may determine whether any other network device has a better sustainability score than the target network device (block 1665). In other words, the process 1600 may determine if any other network device now has a better sustainability score than the selected target network device. If no other network device has a better score, the process 1600 may continue monitoring and receiving updated attributes from the network devices (block 1650).

However, if a different network device has a better sustainability score, in several embodiments, the process 1600 may re-direct the collaboration session activity to the other network device (block 1670). For example, consider a scenario where a collaboration session is initially routed to a network device A because it has an optimal sustainability score. However, during the collaboration session, the network device A experiences a surge in traffic, increasing its energy consumption and lowering its sustainability score. Meanwhile, network device B, located in a region with lower grid energy demand and fewer active connections, now has a better sustainability score than the network device A. In this case, the process 1600 may re-evaluate the sustainability scores in real time and determines that the network device B is now more sustainable. Thus, the process 1600 may re-direct the ongoing collaboration session from the network device A to the network device B to optimize energy efficiency, reduce the overall carbon footprint of the communication, and maximize sustainability goals. In several embodiments, re-directing the collaboration session activity may include re-directing an active collaboration session, an active device registration, active collaboration session control, or the like from a previously selected target network device to a newly selected target network device.

Although a specific embodiment for updating sustainability scores suitable for carrying out the various steps, processes, methods, and operations described herein is discussed with respect to FIG. 16, any of a variety of systems and/or processes may be utilized in accordance with embodiments of the disclosure. For example, the process 1600 may determine the sustainability scores for network devices based on several other sustainability attributes such as site-specific or location-based targets and limits that align with current environmental regulations, net-zero goals, and defined milestones. For instance, a network site may have already exceeded its carbon allowance, influencing the sustainability scores of network devices located in that network site. Additionally, the reliability and quality of power at different times of the day can impact the sustainability score, where regions with more stable, cleaner energy sources can be scored higher. In several more embodiments, newer hardware at a specific location may contribute to a more favorable sustainability score due to lower electricity costs, carbon intensity, and better resource utilization. The process 1600 may also consider sustainability ratings of service providers, such as their environmental, social, and governance (ESG) performance for determining the sustainability scores. The elements depicted in FIG. 16 may also be interchangeable with other elements of FIGS. 1-15, 17, and 18 as required to realize a particularly desired embodiment.

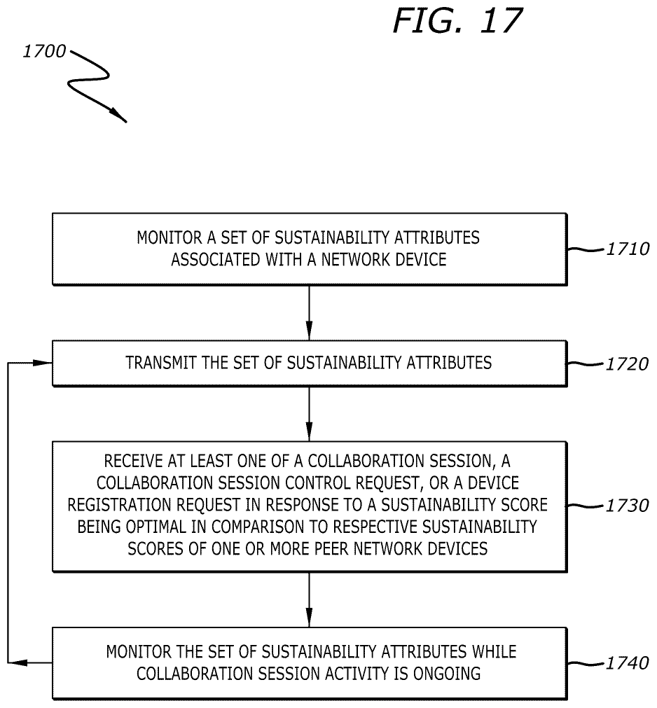

Referring to FIG. 17, a flowchart depicting a process 1700 for transmitting a set of sustainability attributes by a network device in accordance with various embodiments of the disclosure is shown. The network device may be a gateway, a router, a switch, a firewall, or any other network node configured to enable communication. The network device may be capable of translating communication protocols such as SIP to PSTN protocols, enabling collaboration sessions between VoIP systems and traditional telephony systems. The network device may further provide a bridge between a collaboration platform and external communication networks such as the PSTN or mobile networks. In many embodiments, the process 1700 may monitor a set of sustainability attributes associated with a network device (block 1710). Examples of the set of sustainability attributes may include, but are not limited to, an operational status, a utilization rate, energy consumption, an energy source, a grid reliability, a carbon footprint, a regional carbon intensity, or a power usage effectiveness energy consumption, carbon footprint, geographic location, or any other parameter that may have an impact on sustainability. By monitoring the set of sustainability attributes, the process 1700 may ensure that the status of the network device is up-to-date and reflective of real-time sustainability impact of the network device.

In a variety of embodiments, the process 1700 may transmit the set of sustainability attributes (block 1720). That is to say, after monitoring the set of sustainability attributes, the process 1700 may transmit this data to a communication management device to be used in a sustainability scoring operation. For example, the communication management device may compare the sustainability impact, indicated by a sustainability score, of the network device with other peer devices in the network. This sustainability attribute transmission may occur periodically or in response to a trigger (e.g., a change in network device status). For example, the sustainability attribute transmission may happen during a session message or through keep alive messages.

In a variety of embodiments, the process 1700 may receive at least one of an incoming collaboration session, a session control request, or a device registration request in response to a sustainability score being optimal in comparison to respective sustainability scores of one or more peer network devices (block 1730). For example, in a scenario, where the sustainability score of the network device is more favorable than the sustainability scores of the peer network devices, the network device may become an optimal choice for handling collaboration session activities. In other words, the sustainability profile of the network device indicated by the sustainability score, relative to others, can influence its selection in the collaboration session activity routing process.

In still additional embodiments, the process 1700 may monitor the set of sustainability attributes while collaboration session activity is ongoing (1740). In other words, while the collaboration session or communication activity is still ongoing, the process 1700 may continue to monitor the sustainability attributes. The process 1700 may transmit updated sustainability attributes if significant changes occur during the collaboration session activity, such as an increase in workload or energy consumption. Accordingly, a feedback loop may be created by the process 1700, where the sustainability data is continuously refreshed and reported, ensuring optimal management of the network's sustainability impact. The process 1700 then loops back to block 1720, where the updated sustainability attributes are transmitted for further decision-making.

Although a specific embodiment for directing collaboration session activity based on sustainability awareness suitable for carrying out the various steps, processes, methods, and operations described herein is discussed with respect to FIG. 1700, any of a variety of systems and/or processes may be utilized in accordance with embodiments of the disclosure. For example, the process 1700 may declare the network device as sustainable if the set of sustainability attributes fall within a sustainability threshold range. However, if the set of sustainability attributes fall outside the sustainability threshold range, the network device may activate a sleep mode or a green operation mode. During the green operation mode, the network device may disable one or more functionalities that can negatively impact the sustainability score. The elements depicted in FIG. 17 may also be interchangeable with other elements of FIGS. 1-16 and 18 as required to realize a particularly desired embodiment.

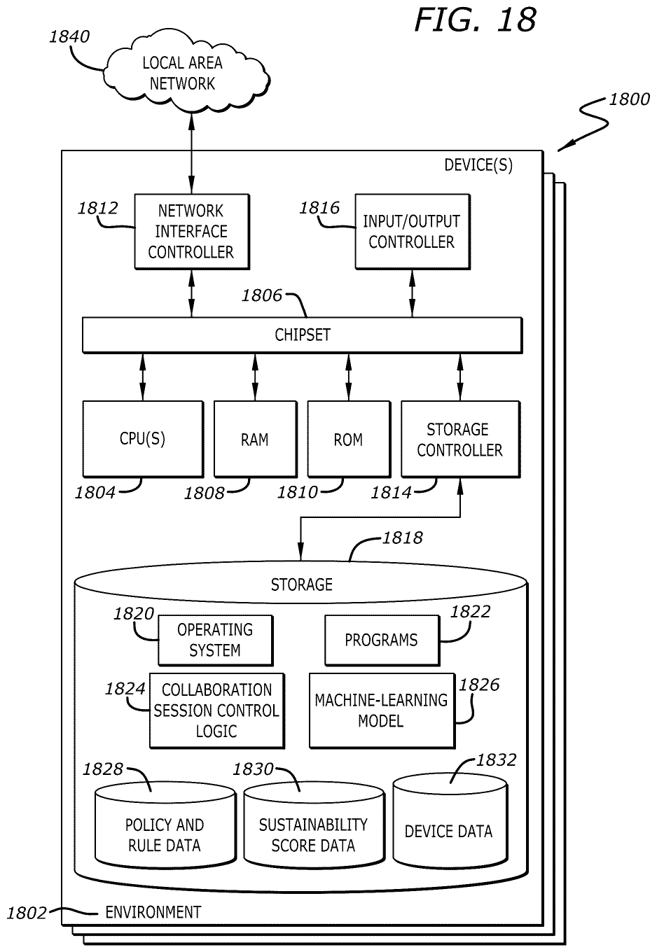

Referring to FIG. 18, a conceptual block diagram of a device 1800 suitable for configuration with a session control logic in accordance with various embodiments of the disclosure is shown. The embodiment of the conceptual block diagram depicted in FIG. 18 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 18 can also illustrate an access point, a switch, or a router in accordance with various embodiments of the disclosure. The device 1800 may, in many nonlimiting examples, correspond to physical devices or to virtual resources described herein.

In many embodiments, the device 1800 may include an environment 1802 such as a baseboard or “motherboard,” in physical embodiments that can be configured as a printed circuit board with a multitude of components or devices connected by way of a system bus or other electrical communication paths. Conceptually, in virtualized embodiments, the environment 1802 may be a virtual environment that encompasses and executes the remaining components and resources of the device 1800. In more embodiments, one or more processors 1804, such as, but not limited to, central processing units (“CPUs”) can be configured to operate in conjunction with a chipset 1806. The processor(s) 1804 can be standard programmable CPUs that perform arithmetic and logical operations necessary for the operation of the device 1800.

In a number of embodiments, the processor(s) 1804 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1806 may provide an interface between the processor(s) 1804 and the remainder of the components and devices within the environment 1802. The chipset 1806 can provide an interface to a random-access memory (“RAM”) 1808, which can be used as the main memory in the device 1800 in some embodiments. The chipset 1806 can further be configured to provide an interface to a computer-readable storage medium such as a read-only memory (“ROM”) 1810 or non-volatile RAM (“NVRAM”) for storing basic routines that can help with various tasks such as, but not limited to, starting up the device 1800 and/or transferring information between the various components and devices. The ROM 1810 or NVRAM can also store other application components necessary for the operation of the device 1800 in accordance with various embodiments described herein.

Additional embodiments of the device 1800 can be configured to operate in a networked environment using logical connections to remote computing devices and computer systems through a network, such as the network 1840. The chipset 1806 can include functionality for providing network connectivity through a network interface card (“NIC”) 1812, which may comprise a gigabit Ethernet adapter or similar component. The NIC 1812 can be capable of connecting the device 1800 to other devices over the network 1840. It is contemplated that multiple NICs 1812 may be present in the device 1800, connecting the device to other types of networks and remote systems.

In further embodiments, the device 1800 can be connected to a storage 1818 that provides non-volatile storage for data accessible by the device 1800. The storage 1818 can, for instance, store an operating system 1820, programs 1822, policy and rule data 1828, sustainability score data 1830, and device data 1832 which are described in greater detail below. The storage 1818 can be connected to the environment 1802 through a storage controller 1814 connected to the chipset 1806. In certain embodiments, the storage 1818 can consist of one or more physical storage units. The storage controller 1814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1800 can store data within the storage 1818 by transforming the physical state of the physical storage units to reflect the information being stored. The specific transformation of physical state can depend on various factors. Examples of such factors can include, but are not limited to, the technology used to implement the physical storage units, whether the storage 1818 is characterized as primary or secondary storage, and the like.

In many more embodiments, the device 1800 can store information within the storage 1818 by issuing instructions through the storage controller 1814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1800 can further read or access information from the storage 1818 by detecting the physical states or characteristics of one or more particular locations within the physical storage units.

In addition to the storage 1818 described above, the device 1800 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1800. In some examples, the operations performed by a cloud computing network, and or any components included therein, may be supported by one or more devices similar to device 1800. Stated otherwise, some or all of the operations performed by the cloud computing network, and or any components included therein, may be performed by one or more devices 1800 operating in a cloud-based arrangement. By way of example, and not limitation, computer-readable storage media can include volatile and non-volatile, removable and non-removable media implemented in any method or technology.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1818 can store an operating system 1820 utilized to control the operation of the device 1800. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1818 can store other system or application programs and data utilized by the device 1800.

In many additional embodiments, the storage 1818 or other computer-readable storage media is encoded with computer-executable instructions which, when loaded into the device 1800, may transform it from a general-purpose computing system into a special-purpose computer capable of implementing the embodiments described herein. These computer executable instructions may be stored as program 1822 (for example, an application) and transform the device 1800 by specifying how the processor(s) 1804 can transition between states, as described above. In some embodiments, the device 1800 has access to computer-readable storage media storing computer executable instructions which, when executed by the device 1800, perform the various processes described above with regard to FIGS. 1-17. In certain embodiments, the device 1800 can also include computer-readable storage media having instructions stored thereupon for performing any of the other computer-implemented operations described herein.

In still further embodiments, the device 1800 can also include one or more input/output controllers 1816 for receiving and processing input from a number of input devices, such as a keyboard, a mouse, a touchpad, a touch screen, an electronic stylus, or other type of input device. Similarly, an input/output controller 1816 can be configured to provide output to a display, such as a computer monitor, a flat panel display, a digital projector, a printer, or other type of output device. Those skilled in the art will recognize that the device 1800 might not include all of the components shown in FIG. 18 and can include other components that are not explicitly shown in FIG. 18 or might utilize an architecture completely different than that shown in FIG. 18.

As described above, the device 1800 may support a virtualization layer, such as one or more virtual resources executing on the device 1800. In some examples, the virtualization layer may be supported by a hypervisor that provides one or more virtual machines running on the device 1800 to perform functions described herein. The virtualization layer may generally support a virtual resource that performs at least a portion of the techniques described herein.

In many further embodiments, the device 1800 may include a session control logic 1824. The session control logic 1824 can be configured to perform one or more of the various steps, processes, operations, and/or other methods that are described above. Often, the session control logic 1824 can be a set of instructions stored within a non-volatile memory that, when executed by the processor(s) 1804 can carry out these steps, etc. In numerous embodiments, the session control logic 1824 may perform various operations related to sustainability aware collaboration session activity routing. In some embodiments, the device 1800 can be a communication management device. In such embodiments, the session control logic 1824 may be configured receive one or more attributes of a plurality of network devices. The one or more attributes may include a set of sustainability attributes or a combination of the set of sustainability attributes and a set of non-sustainability attributes. The set of sustainability attributes may further include an operational status, a utilization status, an energy consumed status, an energy source status, a grid risk status, a carbon footprint status, a geographic carbon intensity status, a water usage effectiveness, a carbon usage effectiveness, or a power usage effectiveness status. The one or more attributes may be received from the plurality of network devices or from a sustainability controller in communication with the plurality of network devices.

The session control logic 1824 may further determine a set of sustainability scores for the plurality of network devices based on the one or more attributes. The session control logic 1824 may select a target network device from the plurality of network devices based on the set of sustainability scores. A collaboration session activity may be directed by the session control logic 1824 to the target network device. Directing the collaboration session activity to the target network device may include routing the incoming collaboration session by the session control logic 1824 to the target network device upon receiving an incoming collaboration session by the session control logic 1824 from an endpoint device.

In numerous embodiments, the target network device may monitor its sustainability attributes during the ongoing collaboration session that it received from the session control logic 1824 and simultaneously keep updating the sustainability attributes. During any one of: after termination of a collaboration session, before initiating the collaboration session, or midway transaction during the ongoing collaboration session, the session control logic 1824 may receive one or more updated attributes from the target network device and thus determine a new sustainability score for the target network device based on the one or more updated attributes. The session control logic 1824 may be further configured to determine whether the incoming collaboration session routed to the target network device is connected successfully. If the collaboration session connection has failed, the session control logic 1824 may select, from the plurality of network devices, a new target network device associated with the next optimal sustainability score. The session control logic 1824 may then re-route the incoming collaboration session to the new target network device.

The selection of the target network device may be further based on one or more rules associated with the incoming collaboration session identified by the session control logic 1824. The session control logic 1824 may determine a set of network devices of the plurality of network devices that satisfies the one or more rules. The network gateway device that the session control logic 1824 ultimately selects for directing the collaboration session activity can correspond to one network device in the set of network devices. Directing the collaboration session activity to the target network device may also include directing a device registration request by the session control logic 1824 to the target network device.

In various embodiments, the storage 1818 can include the policy and rule data 1828. The policy and rule data 1828 may refer to sets of guidelines and conditions that govern how sessions and communication activities are managed within a network. The policy data can define overarching principles or objectives, such as sustainability-aware business goals, while rule data may contain the specific instructions or criteria that dictate how session activities are to be routed. For example, a policy might state that sessions should be routed through devices with lower carbon footprints, while the rules may specify the thresholds for sustainability scores or energy usage that qualify a device for handling a session. Together, the policy and rule data 1828 may ensure that network operations align with both sustainability goals and performance requirements, enabling dynamic and intelligent session routing decisions based on real-time device metrics.

In still more embodiments, the storage 1818 can include the sustainability score data 1830. The sustainability score data 1830 may represent the quantifiable metrics used to evaluate the environmental impact and energy efficiency of network devices or infrastructure components. The sustainability score data 1830 may include measurements related to power consumption, carbon footprint, energy source (e.g., renewable vs. non-renewable), utilization efficiency, and geographic carbon intensity. The sustainability score itself is calculated based on these parameters, often using a weighted algorithm that prioritizes factors such as lower energy use, reliance on renewable energy, operational efficiency, or the like. A higher sustainability score may indicate that a device or system is more eco-friendly, using less energy or generating fewer carbon emissions, while a lower score suggests greater environmental impact.

In a number of embodiments, the storage 1818 can include device data 1832. The device data 1832 may refer to the detailed information and metrics about the network devices involved in communication and session routing. The device data 1832 includes various attributes such as device type (e.g., server, edge device, or gateway), location, current load or utilization, processing capacity, operational status (online/offline), and power consumption. The device data 1832 also includes connectivity characteristics like bandwidth, latency, and network type (e.g., 4G, 5G, Wi-Fi). The session control logic 1824 may utilize the device data 1832 to make informed decisions regarding session routing, resource allocation, and optimizing energy use while ensuring system performance and meeting sustainability goals.

Finally, in numerous additional embodiments, data may be processed into a format usable by a machine-learning model 1826 (e.g., feature vectors), and or other pre-processing techniques. The machine-learning (“ML”) model 1826 may be any type of ML model, such as supervised models, reinforcement models, and/or unsupervised models. The ML model 1826 may include one or more of linear regression models, logistic regression models, decision trees, Naïve Bayes models, neural networks, k-means cluster models, random forest models, and/or other types of ML models 1826.

The ML model(s) 1826 can be configured to generate inferences to make predictions or draw conclusions from data. An inference can be considered the output of a process of applying a model to new data. This can occur by learning from at least the policy and rule data 1828, the sustainability score data 1830, and the device data 1832, and utilize the learning to predict future outcomes. For example, the ML model(s) 1826 can be utilized for determining sustainability scores using supervised learning techniques like linear regression or random forests can forecast sustainability scores using historical data, such as power consumption or network traffic. Unsupervised learning methods, such as k-means clustering, can detect hidden patterns in network behavior and resource usage. To train the ML model 1826, a training dataset of various network devices with known attributes and sustainability scores can be utilized. Preprocessing and feature extraction may be performed to identify the most important data points. This refined data is used to train the ML model(s) 1826, allowing it to learn relevant patterns.

Once trained, the ML model 1826 may be integrated into the device 1800 to make real-time decisions or predictions for maximizing sustainability goals. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1826 may be generated by human/administrator verifications or may compare predicted outcomes with actual outcomes.

Although a specific embodiment for a device suitable for configuration with a session control logic for carrying out the various steps, processes, methods, and operations described herein is discussed with respect to FIG. 18, any of a variety of systems and/or processes may be utilized in accordance with embodiments of the disclosure. For example, the device may be in a virtual environment such as a cloud-based network administration suite, or it may be distributed across a variety of network devices or switches. The elements depicted in FIG. 18 may also be interchangeable with other elements of FIGS. 1-17 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor; and
a memory communicatively coupled to the processor, wherein the memory comprises a session control logic that is configured to:
receive one or more attributes of a plurality of network devices;
determine a set of sustainability scores for the plurality of network devices based on the one or more attributes;
select, from the plurality of network devices, a target network device based on the set of sustainability scores; and
direct a collaboration session activity to the target network device.

2. The device of claim 1, wherein the one or more attributes comprise at least one of: an operational status, a utilization status, an energy consumed status, an energy source status, a grid risk status, a carbon footprint status, a water usage effectiveness status, or a carbon usage effectiveness status.

3. The device of claim 1, wherein the one or more attributes comprise at least one of a geographic carbon intensity status or a power usage effectiveness status.

4. The device of claim 1, wherein the one or more attributes comprise one of a set of sustainability attributes or a combination of the set of sustainability attributes and a set of non-sustainability attributes.

5. The device of claim 1, wherein the one or more attributes are received from the plurality of network devices.

6. The device of claim 5, wherein the one or more attributes are received from the plurality of network devices in at least one of respective collaboration session messages or respective keep alive pings.

7. The device of claim 1, wherein the one or more attributes are received from a sustainability controller in communication with the plurality of network devices.

8. The device of claim 1, wherein the session control logic is further configured to receive an incoming collaboration session from an endpoint device.

9. The device of claim 8, wherein directing the collaboration session activity to the target network device comprises routing the incoming collaboration session to the target network device.

10. The device of claim 9, wherein the session control logic is further configured to:
receive one or more updated attributes from the target network device at termination of the incoming collaboration session; and
determine a new sustainability score for the target network device based on the one or more updated attributes.

11. The device of claim 9, wherein the session control logic is further configured to:
determine whether the incoming collaboration session routed to the target network device is connected successfully;
select, from the plurality of network devices, a new target device in response to determining that the incoming collaboration session routed to the target network device has failed, wherein the new target device is selected based on the set of sustainability scores; and
re-route the incoming collaboration session to the new target network device.

12. The device of claim 8, wherein to select the target network device, the session control logic is further configured to:
identify one or more rules associated with the incoming collaboration session; and
determine a set of network devices of the plurality of network devices that satisfies the one or more rules, wherein the target network device corresponds to one of the set of network devices selected based on the set of sustainability scores.

13. The device of claim 8, wherein directing the collaboration session activity to the target network device comprises routing collaboration session control for the incoming collaboration session to the target network device.

14. The device of claim 1, wherein directing the collaboration session activity to the target network device comprises directing a device registration request to the target network device.

15. The device of claim 1, wherein the set of sustainability scores is determined based on a sustainability policy defining respective weights for the one or more attributes.

16. The device of claim 1, wherein the session control logic is further configured to sort the plurality of network devices in an order based on the set of sustainability scores.

17. The device of claim 1, wherein the session control logic is further configured to:
receive one or more new attributes of one or more network devices of the plurality of network devices; and
update one or more sustainability scores of the set of sustainability scores based on the one or more new attributes.

18. The device of claim 1, wherein the determination of the set of sustainability scores is further based on a machine learning model.

19. A network device, comprising:
a processor; and
a memory communicatively coupled to the processor, wherein the memory comprises a session control logic that is configured to:
monitor a set of sustainability attributes associated with the network device;
transmit the set of sustainability attributes; and
receive at least one of an incoming collaboration session, a session control request, or a device registration request in response to a sustainability score, derived from the transmitted set of sustainability attributes, being optimal in comparison to respective sustainability scores of one or more peer network devices.

20. A method, comprising:
receiving one or more attributes of a plurality of network devices;
determining a set of sustainability scores for the plurality of network devices based on the one or more attributes;
selecting, from the plurality of network devices, a target network device based on the set of sustainability scores; and
directing a collaboration session activity to the target network device.
